(19) United States
(12) Patent Application Publication
(10) Pub. No.: US 2016/0140091 A1
(43) Pub. Date: May 19, 2016

(54) Visual Hierarchy Navigation System

(71) Applicant: Kiran K. Bhat, Brooklyn, NY (US)

(72) Inventor: Kiran K. Bhat, Brooklyn, NY (US)

(21) Appl. No.: 14/923,272

(22) Filed: Oct. 26, 2015

Related U.S. Application Data
(60) Provisional application No. 62/082,050, filed on Nov. 19, 2014.

(51) Int. Cl. G06F 17/22; G06F 3/0486; G06F 3/0484; G06F 3/0481

(52) U.S. Cl. CPC G06F 17/2241; G06F 3/04812; G06F 3/0486; G06F 3/04817; G06F 3/04842

(57) ABSTRACT

The Visual Hierarchy Navigation System described herein comprises a primary graphical object, one or more secondary graphical objects. Sets of secondary graphical objects may depend on some individual secondary graphical objects. Some other individual secondary graphical objects may be executably associated with a set of algorithms.

### PRIORITY CLAIM

This application claims priority to U.S. Provisional Application Ser. No. 62/082,050, filed Nov. 19, 2014. The above references application is incorporated herein by reference as if restated in full.

### BACKGROUND

The GUI, or graphic user interface, is the space between a user and a machine, and features a combination of communicational and interactive components such as buttons, panels, panes, and displays that allow the user to access, manipulate, and convey information. Since the quantity of information available both within a given machine and on the web is vast and the quality of the information is complex, that information has been broken down into content categories, transformed into numerous data types, and internally associated so that each portion of information provides not only the meaning associated with its content, but also its relationship to other portions of information.

The information is frequently stored in databases accessible via applications based on the web, the desktop, or the mobile device. Since the quantity and complexity of the information available is ever-increasing, more powerful tools are needed to exploit that information appropriately. However, while tools are being created to deal with the complexity, it is important that they remain relatively simple so that they can be used by an appropriate user. While exploitation of the information is important to a user in his or her tasks, both personal and in the work-place, the time necessary for such exploitation is limited. The learning curve, or the time and effort required to learn how to use a tool properly, should be kept to a minimum; otherwise the actual value of the tool will be diminished. The value of the tool also lies in the time and effort the user must expend to actually use it. Finally, the tool must be enjoyable to use. Such enjoyment can derive from the aesthetic experience of using the tool—namely, the look and feel of the tool in the context of the application. Of course, the enjoyment also comes from the nature of the task. Filing one's taxes may be inherently painful, but that pain can be reduced if the application tool set is east to use and sleek-looking.

A host of tools have been developed for use in the GUI. Some tools allow users to view information, sort it by various parameters, separate it into distinct portions, group separate portions together, expand or collapse those portions, scroll and pan through information graphics, zoom in and out of information graphics, etc. Other tools allow users to manipulate the information. In a text editor, for example, some tools allow users to change the font size, font type, italicize, etc. In an image editor, some tools allow users to change the color hue, color saturation, brightness, contrast, etc.

Frequently, the user accesses these tools by clicking on a designated button. For applications in which there are only a few such tools, it is acceptable to group the buttons together in one or more button groups—that is, they are all displayed at once, but they are arranged in spatial proximity to related buttons. For applications with many such tools, it is customary to provide a toolbar—an often hanging, sometimes fixed, occasionally docked/dockable pane featuring many buttons. There may be an additional level of organization, such as the use of a Ribbon, which is a task-based grouping pattern using tabs to denote task categories. A group of many buttons appear in each task category when a relevant tab is selected. This latter approach is common in text editors such as Microsoft Word. Furthermore, there may be another set of controls contained within what is called a Command Area. This area is familiar to most users as featuring a File, Edit, View, etc sequence of tabs. Browsers, which are applications used to explore the internet, feature Navigation Tabs. These allow the user to have more than one page of content open at once, while allowing them to focus on one page at a time by hiding the others.

While there has been a lot of development of tools and ways to organize tools, especially in the last few years as tools that had been predominantly features of web applications have migrated to mobile applications and vice versa, it is still necessary to simplify and empower those tools. Also, because the average user has greater exposure to very diverse tool types and forms, new opportunities have opened. Whereas in the previous decades, many users were encountering certain tools for the first time, and those tools had to be labeled or otherwise identified so that the user would be informed as to what the tool was and could do, users are now sufficiently familiar with these tools so that less labeling is necessary. Also, the use of tools has become more intuitive. For example, the user does not need to see a scroll bar or directional arrows to know that he or she can move through pages or options, he or she simply clicks and drags the subject to see what lies beyond it. Furthermore, the user is more comfortable performing complex tasks, and has attained a higher technological agility. These changes have allowed tools to become more streamlined, more interconnected, more seemingly simple and yet functionally complex, and more powerful.

### SUMMARY

The embodiments of the invention disclosed herein pertain to a Visual Hierarchy Navigator, or VHN. In one embodiment, VHN may serve as a component of an application's user interface, permitting a user to access or perform within the application or upon content handled by the application. In another embodiment, VHN may operate as its own application, in which case the user can access or perform actions on one or more other applications or content, whether web, desktop, or mobile-based.

In one embodiment, VHN comprises a primary graphical object. the primary graphical object serves as a focal point for the user; the user will come to recognize that whenever he wishes to fulfill a certain task or commit a particular operation encompassed in the VHN, he or she must hover a cursor over it, select it with a click of the mouse, hit one or more keys of a keyboard, or otherwise indicate to the user interface that he or she desires access to the VHN. the primary graphical object can appear anywhere on a user interface screen. It may be of any shape, color, or size, though in its preferred form it appears substantially circular.

In one embodiment, the primary graphical object is fixed to a particular area in the user interface screen. In another embodiment, it can be moved around at the behest of the user through one or more conventional operations such as drag-and-drop, selecting some aspect of the primary graphical object and subsequently clicking elsewhere on the screen, etc. In yet another embodiment, the primary graphical object features a fix toggle button, which changes its status from fixed to unfixed in space. When the toggle button is set to fixed, no number of keyboard combinations or clicks of the mouse or swipes can change its location. When the toggle button is set to unfixed, it is quite simple to change its location. In one embodiment, the fixed and unfixed states are visually distinguished from each other.

In one embodiment, the VHN may comprise one or more secondary graphical objects. Secondary graphical objects are user interface artifacts that appear adjacent or substantially adjacent to the primary graphical object. Secondary graphical objects may appear in any shape, size, or color, and may appear as either icons, texts, or a combination thereof. Each secondary graphical object may provide the user access to some of the content or functionality of the VHN. In one embodiment, the primary graphical object comprises a content/function toggle button; when the button is in its content state, the secondary graphical objects provide access to content, and when the button is in its function state, the secondary graphical objects provide access to functionality. Content may include images, videos, text documents, or any relevant form in which information is stored and through which it may be expressed. Functionality relates to any action that the user may perform within the user interface. The functionality will generally be embedded in a set of algorithms that are executed during operation of the VHN by selecting a secondary graphical object.

As will be discussed, a secondary graphical object may be selected by the user and that selection may result in the displaying of one or more additional secondary graphical objects in a tier above the selected secondary graphical objects. In this way, the secondary graphical objects in the tier their above the selected secondary graphical object are said to “depend” on the selected secondary graphical object. While such a display is materialized by the executation of algorithms, this application also describes secondary graphical objects that are “executably associated” with a set of algorithms. This “set of algorithms” refer to programming activity extraneous to the displaying of additional secondary graphical objects and instead are connected to the running of additional applications, the displaying of content, or any combination thereof.

In one embodiment, a secondary graphical object may appear in the user interface as an icon, or an image that represents to the user what it is, what it contains, or what it can do. In another embodiment, a secondary graphical object may appear in the user interface as text. In this embodiment, the text may or may not be contained within a shape such as a circle or polygon. In yet another embodiment, the secondary graphical object can appear as a combination of icon and text.

In one embodiment, a first tier of one or more secondary graphical objects may surround the primary graphical object, and one or more secondary graphical objects of a second tier may surround one or more of the one or more secondary graphical objects in the first tier. The analogy of a solar system works well here: a sun (a primary graphical object), may be surrounded by many planets (the first tier of secondary graphical objects), and each of the planets may be surrounded by moons (the second tier of secondary graphical objects). In other embodiments, there may be N tiers of secondary graphical objects, where N is any positive integer between 0 and infinity. Secondary graphical objects in tier N surround secondary graphical objects in tier N−1, which surround secondary graphical objects in tier N−2, etc. If N=1, then that tier surrounds the primary graphical object. From here on the one or more secondary graphical objects that surround a given secondary graphical object will be referred to as the “child” or “children” of the given secondary graphical object, which will be referred to as the “parent”. It would also be accurate to refer to the primary graphical object as a parent and the first tier of one or more secondary graphical objects as children. Secondary graphical objects in the same tier will be referred to as “siblings”.

In one embodiment, one or more secondary graphical objects partially overlap the primary graphical object, such that they can be visually distinguished from the primary graphical object as well as each other, while still indicating that they are components of the same tool. In another embodiment, one or more secondary graphical objects surround the primary graphical object in a ring, but do not touch the primary graphical object.

In one embodiment, the one or more secondary graphical objects of the first tier revolve around the primary graphical object, and the one or more secondary graphical objects of tier N revolve around the secondary graphical objects of tier N−1, as moons revolve in orbits around planets. In this embodiment, the one or more secondary graphical objects cease their revolutions due to some action performed by the user, such as moving the cursor into the orbit of the secondary graphical objects, or hitting one or more keys on the keyboard. As the user moves from lower tiers of secondary graphical objects to higher tiers, all the tiers on or lower than the one he or she is currently hovering over or selecting via the keyboard cease their motion. This aspect of the VHN allows the user to know which ring he or she is accessing at that moment. To illustrate: if there are three tiers of secondary graphical objects, the user can move a cursor to the first tier, so that it ceases revolving, allowing the user to select one secondary graphical object whose branch the user would like to ascend; then the user can move the cursor to a secondary graphical object on the second tier, so that the first and second tiers are both still but the third is rotating; then the user can move the cursor to the third tier, and then all tiers of secondary graphical objects in the VHN becomes still.

In yet another embodiment, the one or more secondary graphical objects are normally fixed in place in relation to the primary graphical object, but revolve around the primary graphical object when some operation is being accomplished by an underlying program, indicating to the user that the computer or some aspect of the program is loading. In this embodiment, the VHN is substantially similar to the hourglass typically associated with loading times.

In one embodiment, the one or more secondary graphical objects of the first tier are positioned away from the primary graphical object in proportion to the number of secondary graphical objects. If there are more secondary graphical objects, all of the secondary graphical objects are further away; if there are few secondary graphical objects, they are close. In another embodiment, the number of one or more secondary graphical objects of the first tier may increase, and in this case, the secondary graphical objects will move further away from the primary graphical object. Likewise, if the number of secondary graphical objects decreases, the secondary graphical objects will move closer. In yet another embodiment, the more secondary graphical objects in tier N, the further away those secondary graphical objects will be from tier N−1; the fewer secondary graphical objects in tier N, the closer they will be to secondary graphical objects in tier N−1.

In one embodiment, the one or more secondary graphical objects of the first tier may converge adjacent to or overlap the primary graphical object, and then disperse further away from the primary graphical object, based on the status of an underlying application. For example, if the application is expecting some action to be taken by the user, the secondary graphical objects may disperse so that they can be visually distinguished from each other, enabling the user to select an appropriate one. After the user has selected a given secondary graphical object and the application has completed its action, the secondary graphical objects are no longer needed, and they may converge back to the primary graphical object. In another embodiment, the primary graphical object features a converge/disperse toggle button. When the user wishes to access the one or more secondary graphical objects, he or she selects the toggle button or otherwise alters it so that the button is in the disperse position. Similarly, when the user no longer wishes to access the one or more secondary graphical objects, he or she changes the button to its converge position. In another embodiment, the secondary graphical objects of tier N similarly converge upon or diverge from the secondary graphical objects of tier N−1.

In one embodiment, the one or more secondary graphical objects of the first tier are normally in a miniature form. In this embodiment, they may partially overlap, be encompassed by, or lie adjacent to the primary graphical object. When the user performs some action to indicate he or she desires access to the one or more secondary graphical objects, the secondary graphical objects will increase in size so that they can be better viewed and distinguished. In one embodiment, the user indicates his or her desire to access the one or more secondary graphical objects by hovering the cursor over the primary graphical object. In another embodiment, the user does so by hovering the cursor over a secondary graphical object. In yet another embodiment, the user does so by manipulating a minimize/maximize toggle button located on the primary graphical object. In yet another embodiment, the secondary graphical objects of tier N similarly minimize or maximize.

In one embodiment, the one or more secondary graphical objects of the first tier may exhibit converge/diverge and minimize/maximize behavior. In this embodiment, there may be a state in which the one or more secondary graphical objects are both minimized and converged upon the primary graphical object, and another state in which the one or more secondary graphical objects are both maximized and diverged away from the primary graphical object. In another embodiment, the secondary graphical objects of tier N similarly converge and minimize or diverge and maximize.

In one embodiment, the primary graphical object and one or more of the one or more secondary graphical objects can be made visible, partially visible, or invisible through any action performed by the user, such as the selection of a visibility toggle button, hovering over the primary graphical object or one of the one or more secondary graphical objects, or through other suitable means. In a visible mode, the primary graphical object may appear on the screen either by itself or in conjunction with one or more secondary graphical objects.

In one embodiment, in a partially visible mode, the primary graphical object may appear on the screen but the secondary graphical objects will not. In another embodiment, the primary graphical object may appear either by itself or with one or more secondary graphical objects in a partially transparent form, so that the user can see through them and look at the underlying screen, panel, or some such user interface artifact, while still remaining aware of the presence of the VHN. In this mode, it may be fully interactive, so that the user can still use all of the VHN features, partially interactive, so that the user can only a few of its features, or non-interactive. If the VHN is partially interactive, features relating to its visibility may be available while others remain unavailable, enabling the user to switch the VHN to a more interactive mode.

In one embodiment, one of the secondary graphical objects in a particular ring may exhibit disperse, maximize, and/or visible behavior or partially visible behavior while the other secondary graphical objects exhibit converge, minimize, and/or partially visible or invisible behavior. In this embodiment, one of the secondary graphical objects may exhibit one or more of the behaviors in the former set as a result of the user hovering over or selecting that secondary graphical object. In another embodiment, that secondary graphical object exhibits that behavior in order to limit the options available to the user.

In one embodiment, a secondary graphical object may have two sides, and each side has a different functionality or provides access to different content. In another embodiment, one side provides access to functionality, and the other side provides access to content. The user may toggle between the sides by hitting a key on the keyboard, selecting a button on the VHN, or through any other suitable means. Alternatively, the user may left-click to access one side, and right-click to access the other side.

In one embodiment, the VHN may exhibit a behavior described here as “Drifting”. During Drifting, the VHN user interface displays a limited range of tiers. In one embodiment, only two tiers are fully visible at a time—the tier over which the user is hovering or has selected, and the tier one step beyond it. In this way, the user will be able to focus on where he is going without being confused by where he has come from. In another embodiment, only three tiers are fully visible at a time—the tier over which the user is hovering or has selected, the tier one step beyond it, and the tier one step before it. This way, the user can focus on both where he has come from and where he is going. In other embodiments, more than three tiers are fully visible at a time, but one or more tiers are not fully visible.

In one embodiment, lower tiers becoming increasingly translucent as the user moves forward in the tiers. In another embodiment, lower tiers simply disappear as the user moves forward in the tiers.

In one embodiment, the VHN may exhibit “Automatic Centering” behavior. During Automatic Centering, the last secondary graphical object the user selected moves so that it occupies the center or substantially the center of the screen.

In another embodiment, the VHN may include a centering button so that this movement may also occur manually. In one embodiment, this centering button may appear in the user interface on a given secondary graphical object, so that when that secondary graphical object is selected, it is centered. In another embodiment the centering button may be situated not in the user interface but on a separate piece of hardware, as discussed below. In this embodiment, when the centering button is selected, the secondary graphical object over which the cursor is then hovering becomes centered.

In one embodiment, one or more secondary graphical objects may be accessible from one or more different tiers. For example, if the VHN is used in the context of art history, Tier 1 may include secondary graphical objects representing time periods in art such as Medieval, Gothic, Renaissance, Baroque, Rococo, etc. If Renaissance is selected, Tier 2 may include Gothic and Baroque secondary graphical objects, since those periods precede and follow the Renaissance, in addition to secondary graphical objects that relate to the artists or art movements within the Renaissance period.

In one embodiment, one or more secondary graphical objects may open up other VHN or VHN-based applications. For example, the user may be using a VHN as an operating system user interface, and the various secondary graphical objects on that VHN may provide access to other VHN applications, such as a VHN-based text editor, a VHN-based internet browser, or a VHN-based computer game. As another example, a VHN-based text editor may include a secondary graphical object that opens a VHN-based spreadsheet editor.

In one embodiment, the VHN may be used as a desktop or program navigator for a desktop or mobile-phone based operating system. A first tier of secondary graphical objects may comprise a user's most commonly selected applications. As a user opens one or more applications, the first tier of secondary graphical objects may comprise the a set of commonly used applications—minus the already opened application(s).

In one embodiment, the VHN may be used to indicate a predicted path. In this embodiment, the secondary graphical objects may represent any conceivable subject matter, type of application, or selectable/inputted data. The indication of the predicted path helps users who are visually impaired by permitting them to establish a commonly used selection of one or more secondary graphical objects; once the commonly used selection is established, it will visually stand out from other possible selections of one or more secondary graphical objects, so that the user need not scrutinize and identify the name or likeness of each individual secondary graphical object. This means also benefits non-visually impaired users who simply wish to speed up their decision-making/selection process. In one embodiment, the pathway is demonstrated gradually. For example, when a user selects a secondary graphical object on a first tier, the predicted secondary graphical object will be visually distinguished in the second tier, but not necessarily the third tier (if there is a third tier). In another embodiment, the pathway is demonstrated at once. For example, when a user clicks the primary graphical object, or a secondary graphical object on the first tier, or even prior, the entire established pathway is already distinguished.

In one embodiment, when the established pathway is visually demonstrated at once, the user need only select or otherwise choose the final secondary graphical object in the pathway in order to validate the pathway as a whole, thereby negating the need to select each secondary graphical object along the way of the pathway. In another embodiment, the user may select a secondary graphical object between the beginning and the end of the pathway. In this embodiment, one or more new pathways may be demonstrated, featuring the second, third, or n'th most commonly selected path.

Distinguishing the established pathway from other possible pathways occurs chiefly visually, but may also occur via sound. The former may employ an outline of the pathway, such that the outline visually encompasses the secondary graphical objects to be selected. Less commonly used paths may also be outlined; these one or more outlines may be visually distinguished by any appropriate means, such as by color, brightness of color, thickness of outline, etc.

Alternatively or additionally, the pathway may be demonstrated by a highlighting or otherwise alteration of the appearance of the secondary graphical objects themselves.

In one embodiment, in which the VHN suggests a common pathway, indication that a given secondary graphical object lies along a common pathway may occur by sound. The appropriate secondary graphical object may be distinguished by a sound emitted by the device employing the VHN. The frequency with which a secondary graphical object is selected can be indicated by the volume or pitch of that sound. Less common or never selected secondary graphical objects may not lead to the emitting of any sound.

In one embodiment, the VHN may display the pathway embodying secondary graphical objects that the user has already selected. The display means may comprise any appropriate means as discussed above.

In one embodiment, the VHN may operate as an auto-completion interface. Auto-completion involves the underlying program predicting a word or phrase that the user wants to type in without the user actually typing it in completely. A letter is received by the underlying program, and one or more words from a word database that begin with that letter are displayed for selection by the user. These one or more words are displayed by the program based on the likelihood that they are relevant to the user. Alternatively, there may be a fixed list of words for a given field in which said letter is entered. For example, if a field calls for diagnoses, then only words that stand for diagnoses will be displayed for selection.

In this embodiment, the user types a letter into a text field. The text field may be located in a secondary graphical object of tier X. Secondary graphical objects of tier X+1 will display the word that the underlying program predicts the user intends to type. In another embodiment, the user can continue typing letters into the text field, and the words displayed by the secondary graphical objects of tier X+1 may refresh to take the additional letters into account when predicting the word the user intends to select. In another embodiment, a secondary graphical object of tier X+1 provides a “None of the above” button by which the user can indicate to the underlying program that the word the user intended to type is not displayed. In one embodiment, when the “None of the above” button is selected, the secondary graphical objects of tier X+1 will display different words from which the user can choose.

In another embodiment, the text field may be located on the primary graphical object, and the secondary graphical objects of tier 1 operate as the secondary graphical objects of tier X+1 do in the previous paragraph.

In one embodiment, the VHN may operate as a form-completion interface. The form-completion interface receives a letter (in which case it may also operate as a word-completion interface) or a word, and then predicts the next word. This next word may be predicted by the underlying program by a combination of grammatical laws limiting the list of words available, that list further limited by relational scores given to each pair of words. In a form such as a medical report, the user can input, either completely or partially, one or more medical indications, valid reasons for using a certain test, medication, procedure, or surgery. The one or more indications will be matched in the underlying program to predetermined tests, medications, procedures, and/or surgeries, which will then be displayed as one or more secondary graphical objects, and the user may select one or more of these secondary graphical objects. As words or terms are selected, they are entered into a report sheet, which may be a separate document. In one embodiment, the VHN is used as a toolset in various editors, such as page layout and formatted text editors, image editors, vector-graphics editors, website builders, GUI builders and code editors, and generic text editors. In this embodiment, the VHN serves as a palette to provide tools to operate on the content on a canvas. Secondary graphical objects of the VHN may include any and all of the usual assortment of tools, but these tools are organized according to the capabilities of the VHN.

In the case of an image editor, for example, the first tier of secondary graphical objects may include a “selection” secondary graphical object, a “manipulate” secondary graphical object, and a “paint” secondary graphical object. The selection secondary graphical object may open up to a second tier of secondary graphical objects featuring a “rectangle select tool”, “ellipse select tool”, and a “free select tool”. The “manipulate” secondary graphical object may open up to a second tier of secondary graphical objects featuring “scale”, “shear”, and “perspective”. The “paint” secondary graphical object may open up to a second tier of secondary graphical objects featuring “bucket”, “pencil”, and “paintbrush”.

In the case of any program, the VHN may be used in place of the traditional command area. For example, secondary graphical objects on the first tier may include “file”, “edit”, “view”, and “help”. The “file” secondary graphical object may open up to a second tier of secondary graphical objects featuring “save”, “save as”, “open”, and “print”. Also, the secondary graphical objects may include the minimize/maximize/close buttons that appear in almost all windows.

In the case of a browser, the VHN may be used in place of substantially the entire user interface except for the display screen, and there are endless varieties of organizing the tools traditionally found in the browser UI. For example, the first tier of secondary graphical objects may include “navigation”, which opens up to a second tier of secondary graphical objects featuring “back”, “forward”, and “home”; it may include “tools”, which opens up to “zoom”, “save page as”, and “settings”; and it may also include “tabs”, which opens up to the one or more tabs that the user is currently accessing.

The VHN can be used to navigate content. Databases of images and/or text can be organized according to categories, and the content and categories can be organized using the secondary graphical objects. For example, an interactive software designed to educated a user about European classical music may be organized as follows. The first tier of secondary graphical objects may represent “Medieval”, “Renaissance”, “Baroque”, “Classical”, “Romantic”, and “Modern” categories. If the “Baroque”category is selected, a second tier of secondary graphical objects may be displayed representing “1600-1650”, “1650-1700”, and “1700-1750”. If “1650-1700” is selected, a third tier of secondary graphical objects may be displayed representing “Henry Purcell”, “Antonio Vivaldi”, and Johann Sebastian Bach”. If “Henry Purcell” is selected, a fourth tier of secondary graphical objects may be displayed representing “The Princess of Persia”, “The Virtuous Wife”, and “Man that is Born of a Woman”. If any of these secondary graphical objects are selected, a music file described by that secondary graphical object is opened, and that piece of music plays to the delight of the listener.

In one embodiment, the VHN is used to navigate a travel itinerary. A user may identify a starting location and/or destination in a text prompt, drop down-menu, or similar UI artifact in the primary graphical object. Subsequently, a first tier of nearby locations may appear from which the user may begin his journey. For example, if a user identifies his or her starting location as 221 Easy Street, Brooklyn, N.Y. and his destination as 360 Hard Avenue, Queens, N.Y., secondary graphical objects on the first tier may comprise nearby subway stations or bus-stops. If any of the secondary graphical objects are selected, then a second tier may be displayed comprising either the ultimate destination, or other subway stations or bus-stops that take the user closer to his destination.

In another embodiment, the VHN, as used to navigate a travel itinerary may further comprise intermediary steps. After a secondary graphical object on the first tier is selected, that secondary graphical object may move radially outward to the second tier, thereby revealing a new first tier of mid-points between the primary graphical object and the second tier. For example, if the user enters a starting location as somewhere in Brooklyn, N.Y., and a destination as somewhere in Moscow, Russia, the first tier available may comprise secondary graphical objects representing different airports. Once the airport is selected, the secondary graphical object representing that airport can migrate to the second tier, and a new first tier representing means of getting to that airport appear, i.e., car, taxi, etc.

In another embodiment, the VHN, as used to navigate a travel itinerary comprising intermediary steps may permit the intermediary steps to be manually entered by the user. In this embodiment, the user selects not the means to reach his or her destination, but some other sub-destination. For example, If the user's starting location is New York and his or her destination is Russia, he or she may select an intermediary or sub-destination as Norway.

In one embodiment, the VHN is controlled by a dedicated hardware apparatus, from here on referred to as a Pilot. In one embodiment, the Pilot is similar to the mouse in that it is manipulated by substantially one hand.

In one embodiment, the Pilot has a directional pad featuring up, down, left, and right directions, which enable the user to navigate through the VHN. By pressing “up”, the user moves from a parent to one of its children. By pressing “down”, the user moves from a child to its parent. By pressing “left” or “right”, the user moves from one sibling to another. In one embodiment, if the siblings are in a ring around their parent, to press right is to cycle through the siblings clockwise, and to press left is to cycle through the siblings counter-clockwise. The location where the Pilot is currently residing is referred to as, appropriately, Location.

In one embodiment, the Pilot has a Select button; when the Select button is pressed, the secondary graphical object that is currently in the Location is activated so that its functionality or content is accessed by the user. In one embodiment, one or more of the buttons on the primary graphical object described above (fix toggle, visibility toggle, content/function toggle, etc.) may be selected in this manner. In another embodiment, if the Select button is held down when the Location is situated at the primary graphical object, the primary graphical object may be moved around the user interface by using the directional pad.

In another embodiment, the Pilot may feature any of the buttons already ascribed to the primary graphical object. For example, the converge/diverge button may be positioned on the Pilot in addition or in lieu of positioning it on the primary graphical object.

In one embodiment, the Pilot has a Return button; when the Return button is pressed, the Location is situated at the primary graphical object.

In one embodiment, the Pilot is attached to a keyboard. In another embodiment, the Pilot is attachable to a keyboard. In yet another embodiment, the Pilot is separate from a keyboard. In one embodiment, the Pilot is attached to a mouse. In another embodiment, the Pilot is attachable to a mouse. In yet another embodiment, the Pilot is separate and can be used in addition to a mouse. In another embodiment, the Pilot can be used in place of a mouse.

In one embodiment, the VHN distinguishes secondary graphical objects from tiers, or positions, closer to the primary graphical object from secondary graphical objects from tiers, or positions, further from the primary graphical object. This can be done visually by using any spectrum of change or gradient. For example, the spectrum can be brightness of color (fading from white to black or black to white), the color spectrum (red to orange, yellow, green, blue, violet, or in reverse), or numerical (1 . . . 8, 9, 10, or in reverse). Distinguishing can also be done sonically. For example, the spectrum can range from low pitched sounds to high pitches sounds, or in the reverse order.

Alternatively, only the terminal secondary graphical objects—that is, those that are executably associated with a set of algorithms and are not depended upon by other secondary graphical objects—may be distinguished in the above described manners.

In yet another embodiment, a sequence of selections of secondary graphical objects is determined before-hand by an operator of the visual hierarchy navigation system. This sequence of selection generally means that a first secondary graphical object is selected, followed by a second secondary graphical object that depends on it, followed by a third secondary graphical object that depends on the second, continually until a final secondary graphical object is selected that is executably associated with a set of algorithms. In one version of this embodiment, the predetermined sequence is distinguished, using either the graphical or the sonic methods described above. In one variation of the sonic method, a sound is emitted when the user strays from the pre-determined path. In another version, a sound is emitted when the user tentatively selects a secondary graphical object on the pre-determined path. Using the graphical method, the secondary graphical objects on the pre-determined path are graphically distinguished from the secondary graphical objects that are not on the path.

ESYMED SUMMARY. Embodiments of an invention relate to an office management system. Aspects include a patient database, means for creating appointments for the patients, and a calendar to organize and display the appointments. Other aspects include means to add information to a patient's file, including photographs, procedure history, etc.

In one embodiment, the Office Management Tool comprises a scheduler means for organizing appointments. This means may include a link to a separate page, a drop down menu, a spoke on a hub and spoke, or an expandable/collapsible pane, panel, or cell.

In one embodiment, the scheduler comprises a calendar means for indicating what appointments are scheduled and how many are scheduled for a given date. This means may include a link to a separate page, a drop down menu, a spoke on a hub and spoke, or an expandable/collapsible pane, panel, or cell. The current date, which is the date that matches the real world calendar date, may be displayed in one color, while the date selected by the user may be displayed in another color.

In one embodiment, the each day displayed on the calendar is also a clickable or otherwise actionable; when the link for a given day is selected, the user interface displays the Time Slots for that day, which will be described later.

In one embodiment, the calendar may be scrollable or similarly actionable, so that a user may access a prior or subsequent month by clicking arrows pointing hither and thither or dragging a button from one side of the Calendar to another. In one embodiment, the Calendar becomes visible when a Calendar Icon is selected, and hidden when that Calendar Icon is selected again. In another embodiment, the number of due dates scheduled for a certain date appear on that date in the Calendar.

In one embodiment, the Scheduler features a Time Slots display. In one embodiment, the Time Slots display features a list of time increments, such as one hour increments, half-hour increments, etc. In this embodiment, the increments are fixed and cannot be changed by the user. In another embodiment, the user can select the time intervals he or she wishes to use to view the appointments for a given day.

In one embodiment, the Scheduler features an Add Appointment button. When this button is selected, a drop down or accordion menu opens, featuring fields. These fields may include the name of the patient, the name of the referring physician, the date of the appointment, the start time of the appointment, the end time of the appointment, the status of the appointment (whether it is complete or not), the phone number of the patient, an area for comments, and the procedure to be accomplished. Note that this list is not complete nor is it closed, and any reasonable set of categories will suffice.

The calendar automatically updates to incorporate a new appointment. If one of the fields is entered incorrectly—for example, the area code is missing in the phone number—then an error message occurs alerting the user that the appointment has not been incorporated. In one embodiment, an appointment will still be incorporated even if errors are present in one or more fields.

In one embodiment, the scheduler identifies and displays the total number of appointments for a given day. In another embodiment, the scheduler identifies and displays the number of appointments that have been completed for that day. In yet another embodiment, the scheduler identifies and displays the number of appointments left for a given day.

In one embodiment, the Office Management Tool comprises a Patient Search for searching through a database of patients. This Patient Search may be accessed from a link to a separate page, a drop down menu, a spoke on a hub and spoke, or an expandable/collapsible pane, panel, or cell. The search query features may limit the search, at the command of the user, to patients of one gender, patients who have appointments on a given day, patients undergoing a particular procedure, patients whose appointments are scheduled at a particular office, as well as other categories. The user may search by first name, last name, social security number, gender, phone number, or date of birth. The results of the search query are displayed in the user interface. When a search is completed, the user may order the search results according to one or more of these categories, i.e., ordering the list by last name in alphabetical or reverse alphabetical order. In another embodiment, the user interface displays a list of all patients whose first or last name begins with a letter selected by the user.

In one embodiment, the Office Management Tool comprises an Add Patient means. This means may include a link to a separate page, a drop down menu, a spoke on a hub and spoke, or an expandable/collapsible pane, panel, or cell. The Add Patient means comprises one or more drop-down menus, fields, radio buttons, toggle buttons, or other user interface interactive means. A non-exclusive list items include a first name, last name, social security number, date of birth, gender, email, and phone number.

In one embodiment, the user can create an appointment for the patient on the same page that he or she adds the patient to the system. This Add Appointment feature is already described above.

In one embodiment, the Office Management Tool comprises an Inbox. This inbox may appear as its own link to a separate page, a drop down menu, a spoke on a hub and spoke, or an expandable/collapsible pane, panel, or cell. The Inbox comprises a table of patient names. Associated with each name are visit dates, reports, images, requisition numbers, status, reception dates, sign of, remarks, and a file upload.

The Patient Management Tool comprises one or more Accordion menus. An Accordion menu is a vertically stacked list of sub-menus. The sub-menus remain collapsed, so that only the name of the sub-menu is visible, until selected. Upon selection, the sub-menu opens or expands, so that the user can access the functionality within. While generally Accordion menus permit several sub-menus to remain open at once, the Office Management Tool described herein may also comprise One-Note Accordion menus. A One-Note Accordion menu permits only one sub-menu to remain open at a given time. When a second sub-menu is selected, the first sub-menu closes.

In one embodiment, the Patient Management Tool comprises an Image Organization Means. In one embodiment, the Image Organization Means comprises an accordion menu. In this embodiment, each sub-menu is labeled with a given date, and its contents include thumbnails of images taken on or assigned that given date. In one embodiment, one or more images can be opened by selecting their thumbnails, and these images can be compared displayed simultaneously in order to compare them. In one embodiment, each Report, to be described below, has its own accordion menu that displays images uploaded or otherwise entered into the report. In another embodiment, an image-based accordion menu may be assigned to each patient account. In this way, the accordion shows a chronological picture history of the patient.

In one embodiment, the Patient Management Tool comprises a Health Insurance Claim Form. In one embodiment, the Health Insurance Claim Form comprises an accordion menu. In this embodiment, each sub-menu is labeled with a different field, including Insurance Name, Insured's IC Number, Patient's Name, Patient's birth date, Insured's Name, Insured's Policy or Group Number, Insured's Date of Birth, Insured's Employer's name or school name, Insured's insurance place name or program name, Patient's Address, Patient's relationship to Insured, Insured's address, Patient Status, as well as any other facts or figures relevant to the an insurance claim form.

In one embodiment, the Patient Management Tool comprises a Reports section. The Reports section comprises a template panel, in which a template is displayed. The template comprises a set of categories and fields in which a user can enter or select one or more words, terms, or sentences.

In one embodiment, the Reports section comprises a template drop down menu from which a template can be selected. That template is then displayed in the template panel. In another embodiment, the Reports section further comprises an image panel, in which one or more images relating to a given report are displayed. In one embodiment, these images can be expanded so that they can be seen in greater detail, either individually, or as a group, or they can be selected to open up in another page.

In one embodiment, the Reports section comprises a details panel. When one of the categories in the template panel is selected, a list of terms and/or categories of terms are displayed in the details panel. If a category is selected, one or more terms are displayed in a drop-down menu or as an accordion menu. One or more of these terms can be selected to populate the template panel fields. In one embodiment, the fields are formatted to receive codes, wherein the codes represent terms or words. For example a diagnosis field may only accept diagnosis codes.

In one embodiment, the diagnosis codes, frequently referred to as CPT (current procedural terminology) codes, are matched to advertisements in a process known as Initiated Narrowcasting Advertising. CPT codes that are frequently entered by a given user may be automatically matched to advertisements embedded in the program, which are then displayed somewhere in the program's user interface, or those codes are uploaded via a network connection to one or more databases and/or processing locations. Advertisements, which are tagged automatically or manually to those code, are then downloaded by the one or more computers hosting the program; these advertisements are then displayed somewhere on the program's user interface.

In one embodiment, the Reports section features a signature block. This signature block can be displayed separately from the other components of the Reports section, or as part of another component. For example, it can appear as a field within the template panel.

In one embodiment, the Reports section comprises an export button. When selected, the information entered into the Reports section is transformed into a document such as a PDF. This document can then be saved to the user's computer, emailed, or stored elsewhere in the Patient Management Tool.

In one embodiment, the Reports section may suggest a term or tag to the user; if this term or tag is verified, either through a selection or by lack of a rejection substantiated by a selection, then that term or tag attaches to the report. One or more terms or tags may be searched in a report database by the user, thereby causing the display of the one or more reports that have those one or more terms or tags attached to them.

In one embodiment, the fields available in the template panel change as information is entered into the template panel. In one embodiment, the page may reload so that new fields become displayed. In another embodiment, fields may remain visible, but information cannot be entered into them. In one embodiment, fields and/or field terms become available/unavailable due to the diagnosis entered. In this embodiment, only procedures that are indicated as approved for a given diagnosis by a database internal or external to the Patient Management Tool may be entered in a procedure field.

In one embodiment, the Patient Management Tool may receive visual data from an optical instrument that records images and can transmit them to another location. This visual data may comprise static images, such as photographs, or dynamic images, such as video. The Patient Management Tool may comprise a display window, which may be a part of another page or its own separate page. The display window displays the visual data, which is either received and displayed in real time, or is stored on a computer readable medium such as the RAM, a CD, or a hard disc.

In one embodiment, the visual data may be modified or annotated within the display window of the Patient Management tool or in a separate image editor. The user may interact with the visual data by clicking or selecting an area on the visual data, whether it is a static image or a video. If the visual data being clicked or selected is a video, then the click or selection will receive a time stamp for the time interval and duration for which the area on the visual data is selected. This click or selection will be visible when the image or video is displayed and/or played.

In another embodiment, the user may leave a comment directed to the click or selection. This comment may comprise text, shapes, drawings, and/or colors. In one embodiment, the comment may be displayed alongside the clicked or selected area. In another embodiment, a line will be drawn between the clicked or selected area and an area in which the comment is displayed.

In one embodiment, the visual data, with or without click or selection points and/or comments are accessible in real time over a network, enabling another user to view, click, select, and/or comment on various areas. The visual data may be captured by the optical device, transmitted to a local computer, saved in a computer data storage medium, uploaded via a network to one or more servers, and downloaded to one or more other data storage mediums. In one embodiment, the image can only be uploaded to a virtual private network.

The optical instrument that provides the visual data may be an endoscope, as described elsewhere in this application.

In one embodiment, the Patient Management tool displays the image captured by the endoscope in real time. In another embodiment, the endoscope has a capture button; when pressed or otherwise selected by the user, the endoscope captures an image through the use of its image-capturing means, such as a camera. This analog image is recorded digitally onto a computer readable storage device, such as RAM, a hard drive, or a disc, and then may be displayed by the Patient Management Tool. In one embodiment, the Patient Management Tool uploads the image to a server or another computer via a network. In another embodiment, the endoscope has a freeze button; when pressed or otherwise selected by the user, the image displayed in the display window is not replaced by any other image, but is instead held statically, until the freeze button is unpressed or unselected by the user. In this sense, it is “frozen” in place until “unfrozen”. In one embodiment, if the freeze button is held for a predetermined duration, then the frozen image is automatically saved permanently to a computer readable storage device, preferably a hard drive. If the freeze button is held less than a predetermined duration, then the frozen image is saved only temporarily in the RAM; once the image is unfrozen, it is deleted from the RAM.

In one embodiment, one or more users who are accessing the same visual data or data set may also communicate in a text message box in the same or a separate page from that in which the visual data is displayed. In another embodiment, one or more users may also communicate through a microphone and speaker system; one or more computers may have a microphone and/or a speaker through which they may give and/or receive vocal communications.

VHN Patient Management Tool. In one embodiment, the Patient Management Tool comprises a VHN, described elsewhere in this application.

In one embodiment, a spoke comprises a link to a Patient Database; when selected, the user interface displays a list of patients.

In another embodiment, a parent spoke of tier M is surrounded by one or more children spokes of tier M+1, each representing a range of letters. For example, one child may represent letters A-F, another child may represent letters G-M, and a third child may represent letters N-Z. These children spokes may comprise links; when selected, the user interface displays a list of patients whose names, first or last, fall within that range.

In one embodiment, each spoke of tier M+1 may be surrounded by one or more spokes of tier M+2. In this embodiment, each of the spokes of tier M+2 represent the files of individual patients. These spokes of tier M+2 may comprise links; when selected, the user interface displays a page displaying attributes about the patient, such as his or her name, age, gender, and/or list of appointments scheduled for that patient. There may also be some interactivity on the page—for example, the means to schedule another appointment, to view or upload files relevant to the patient, or to contact the patient directly.

In one embodiment, the spoke representing an individual patient may be surrounded by one or more spokes of tier M+3. In this embodiment, the spokes of tier M+3 represent attributes relevant to the patient. For example, one spoke may display the patient's age, another may display his or her gender, while another may display his or her doctor's name. In another embodiment, each spoke of tier M+3 may comprise links; when selected, the user interface displays a page relevant to that spoke. For example, one spoke may represent basic patient attributes, and its dedicated page displays the patient's name, gender, doctor's name, date of next appointment, etc., while another spoke may represent files, such as images taken of or reports made about the patient during an appointment.

In one embodiment, a spoke comprises a link to a scheduler; when selected, the user interface displays the scheduler as described above. In another embodiment, a spoke of tier W representing a scheduler is surrounded by one or more spokes of tier W+1. In this embodiment, one of the spokes of tier W+1 may represent a calendar, another may represent time slots, and a third may represent the creation of an appointment. In another embodiment, each spoke of tier W+1 may comprise links; when a link is selected, the user interface displays a page relevant to that spoke. For example, if the spoke representing a calendar is selected, a page featuring a calendar is displayed.

In one embodiment, a spoke representing a calendar may be surrounded by one or more spokes representing actions relevant to a calendar. For example, one of these one or more spokes may represent the action of viewing appointments for the current calendar date. Another of these one or more spokes may represent the action of viewing appointments for the next calendar date. Yet another of these one or more spokes may represent viewing intervals of time in which there are no appointments scheduled. Another of these one or more spokes may represent the creation of an appointment.

In one embodiment, a spoke representing the creation of an appointment may be surrounded by one or more spokes representing actions relevant to scheduling appointments. For example, one of these one or more spokes may represent the name of a patient. This spoke may comprise a drop down menu, a field with auto-completion, or any reasonable means of specifying a given patient. Another of these one or more spokes may represent the date for which an appointment is to be scheduled. This spoke may comprise a drop down panel comprising a calendar, and the day of the appointment may be selected by selecting the appropriate day on the calendar. Alternatively, one or more fields accessible by the spoke may be formatted to receive a month, day, and year. Another of these one or more spokes may represent the time for which an appointment is to be scheduled. This spoke may comprise one or more fields formatted to receive an hour and minute. Alternatively or in the addition, the spoke may comprise a drop-down menu of hours, minutes, and the choice of AM or PM.

In one embodiment, a spoke representing a Patient Search may be surrounded by one or more spokes representing actions relevant to searching through a database of patients. For example, one of these one or more spokes may comprise a search field in which the user can enter a name. The search field may be limited to first or last name. Results for the search query may be displayed on a separate page, or contained within a drop down menu or similarly actionable user interface artifact through which one of the displayed names can be selected. One or more of these one or more spokes may represent actions such as limiting a search to a last name, limiting the search to male or female patients or including both genders within a search list, or limiting the search by any other attribute that added to a patient profile or results from actions performed upon the database through the user interface.

In one embodiment, a spoke representing the creation of a patient profile may be surrounded by one or more spokes representing actions relevant to the creation of a patient profile. For example, one of these one or more spokes may represent principal attributes such as a patient's name, which may be separated into first and last, the patient's contact information, including one or more phone numbers, home addresses, and email addresses, the patient's emergency contact information, including the name of one or more other individuals, and the phone numbers or email addresses through which those individuals can be reached. Another of these one or more spokes may represent scheduling information, which is described substantially above. Another of these one or more spokes may represent billing information, which will be described below.

In one embodiment, a spoke of tier B represent the billing of a patient may be surrounded by one or more spokes of tier B+1 representing actions relevant to the billing of a patient. This spoke may be the child of a spoke of tier B−1 representing an appointment with a given patient, in which case one of the one or more spokes of tier B+1 may represent printing out a bill, another may represent the printing of an envelope with the patient's address, another may represent a checkbox indicating that the envelope with the enclosed bill has been mailed out, and another may represent that a check has been received or that the bill has been paid. If the spoke of tier B−1 represents a given patient, then the one or more spokes of tier B+1 may represent individual appointments for which a bill must be sent out, each of which may be surrounded by one or more spokes of tier B+2, which correspond to the printing and mailing of the bill.

In one embodiment, the spokes of tier C may represent the actions of billing an insurance company for a given appointment. In one embodiment, the spoke of tier C may comprise a link to the Health Insurance Claim Form described above. In another embodiment, the spoke of tier C may be surrounded by one or more spokes of tier C+1. Spokes of tier C+1 may represent one or more fields relevant to submitting an insurance claim to an insurance company, such as Insurance Company Name, Insured's IC Number, Patient's Name, Patient's birth date, Insured's Name, Insured's Policy or Group Number, Insured's Date of Birth, Insured's Employer's name or school name, Insured's insurance place name or program name, Patient's Address, Patient's relationship to Insured, Insured's address, Patient Status, as well as any other facts or figures relevant to the an insurance claim form.

In one embodiment, a spoke of tier R may represent Reports. In one embodiment, spokes of tier R+1 represent one or more fields, such as Clinical History, Indications, Consent, etc. These fields may be entered manually, or may be selected, causing spokes of tier R+2 to appear. These spokes of tier R+2 may be terms, codes, or words that “complete” the fields in tier R+1, or may by categories for other terms and codes. In this latter case, if they are selected, then spokes of tier R+3 appear. These iterations can occur until it is no longer necessary to introduce categories to contain terms, codes, or words. In one embodiment, a spoke may represent the exportation of a report into another document. This document may be saved to the user's computer, emailed, or uploaded to a server.

Image Capturing Summary. Typically, images are captured in a raw format, converted into a digital format, saved temporarily in the browser's cache (?) until they are uploaded via the internet to one or more servers, and then deleted. Before the images are uploaded, they are at risk of being erased if the browser crashes.

Here, the images are saved locally but in a permanent manner, such as to a hard disk, and then deleted once they are uploaded. This protects the images from intervening errors or mishaps.

An endoscope is a medical device used in an endoscopy, the interior examination of an organ or body cavity. Unlike topical examinations, in which there is a barrier such as the epidermis that prevents both sight and substantially touch, an endoscopy involves the insertion of the endoscope into the organ or body cavity, thereby permitting sight into a location that is otherwise hidden and dark. Unlike other medical imaging devices, such as X-Ray CT, there are no adverse risks resulting from radiation or other exposures.

The endoscope may comprise a lighting system to illuminate the area, an image transmitting system for creating an image of the area and transmitting the image to the user in a way that the user can see the image, and a tube or cable through which the image is transmitted. In addition, one or more medical instruments may be attached to the endoscope for purposes such as capturing a sample, applying treatment, or removing unwanted growths.

There are many areas in which an endoscope can be employed; the name, structure, and components of the endoscope differ by these areas. For example, when the endoscope is used to explore the rectum or anus, it is referred to as a proctoscope and comprises a short tube. When the endoscope is used to explore the lower respiratory tract, it is referred to as a bronchoscope and comprises a long, thin tube. Generally, endoscopes are entered into body cavities or organs through naturally occurring orifices, but there are some endoscopes, known as Laparoscopes, designed to be inserted through surgically created orifices. In addition to the numerous medical applications, endoscopes or devices substantially similar to endoscopes are frequently utilized in such areas as criminal surveillance, technical systems, and film as art. For the purposes of this application, “endoscope” refers to any device that captures visual data, whether static or dynamic, and transforms it into digital data, whether in the medical field or any other field.

### BRIEF DESCRIPTION OF THE DRAWINGS

FIG. 1 is a view of an exemplary user interface with primary and secondary graphical objects.

FIG. 2 is a view of an exemplary user interface with an initial and depending set of secondary graphical objects.

FIG. 3 is a view of an exemplary user interface featuring a user generated movement instruction.

FIG. 4 is a view of an exemplary user interface after the user generated movement instruction has been received and executed.

FIG. 5 is a view of an exemplary user interface when the primary graphical object is fixed.

FIG. 6 is a view of an exemplary user interface when the primary graphical object is unfixed.

FIG. 7 is a view of an exemplary user interface featuring a user selection of a secondary graphical object in position P.

FIG. 8 is a view of an exemplary user interface featuring an initial set moved to position P−1 and a depending set displayed in position P.

FIG. 9 is a view of an exemplary user interface featuring a selected secondary graphical object displayed in position P=0, overlapping the primary graphical object.

FIG. 10 is a view of an exemplary user interface featuring a user selection of a secondary graphical object in a depending set

FIG. 11 is a view of an exemplary user interface featuring a third set of secondary graphical objects with the initially selected graphical object in position P=0.

FIG. 12 is a view of an exemplary user interface featuring the display of a selected secondary graphical object in position P=0 and ceasing the display of the primary graphical object.

FIG. 13 is a view of an exemplary user interface featuring a user selection of a secondary graphical object executably associated with a set of algorithms.

FIG. 14 is a view of an exemplary user interface featuring the rotation of a selected secondary graphical object executably associated with a set of algorithms after those algorithms have been executed but before they have finished executing.

FIG. 15 is a view of an exemplary user interface featuring a tentative user selection of a secondary graphical object.

FIG. 16 is a view of an exemplary user interface featuring a tentative user selection of a secondary graphical object.

FIG. 17 is a view of an exemplary user interface featuring a partially transparent display of a secondary graphical object.

FIG. 18 is a view of an exemplary user interface featuring the rotation of secondary graphical objects.

FIG. 19 is a view of an exemplary user interface featuring a graphical distinguishing of secondary graphical objects based on their position.

FIG. 20 is a view of an exemplary computer system.

FIG. 21 is a flowchart of an exemplary process.

FIG. 22 is a flowchart of an exemplary process.

FIG. 23 is a flowchart of an exemplary process.

FIG. 24 is a flowchart of an exemplary process.

FIG. 25 is a flowchart of an exemplary process.

FIG. 26 is a flowchart of an exemplary process.

FIG. 27 is a flowchart of an exemplary process.

FIG. 28 is a flowchart of an exemplary process.

FIG. 29 is a flowchart of an exemplary process.

FIG. 30 is a flowchart of an exemplary process.

FIG. 31 is a flowchart of an exemplary process.

FIG. 32 is a flowchart of an exemplary process.

FIG. 33 is a flowchart of an exemplary process.

FIG. 34 is a flowchart of an exemplary process.

FIG. 35 is a flowchart of an exemplary process.

FIG. 36 is a flowchart of an exemplary process.

### DETAILED DESCRIPTION

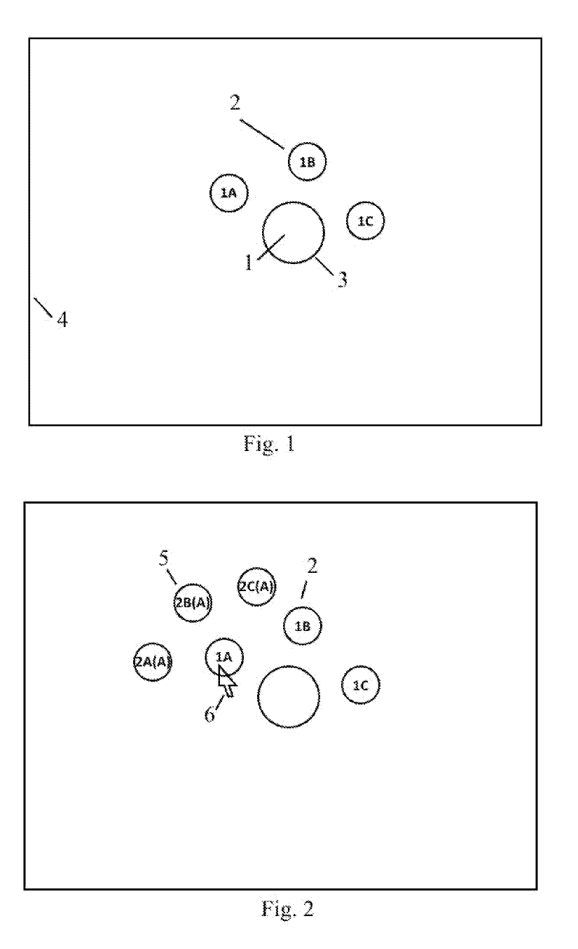

In the embodiment shown in FIG. 1, a visual hierarchy navigation system comprising a primary graphical object 1 and secondary graphical objects 2. The primary graphical object serves as a kind of anchor for the system, and operates at least initially as a centralizing agent for the other graphical objects and operations. In this figure, the primary graphical object is displayed in a first region of a display 3 device. The secondary graphical objects are individually distinguishable from one another based on their graphical locations and their unique appearances, as displayed on the display device 4. The secondary graphical objects approximately surround the primary graphical object, although they may at least partially overlap the primary graphical object as well.

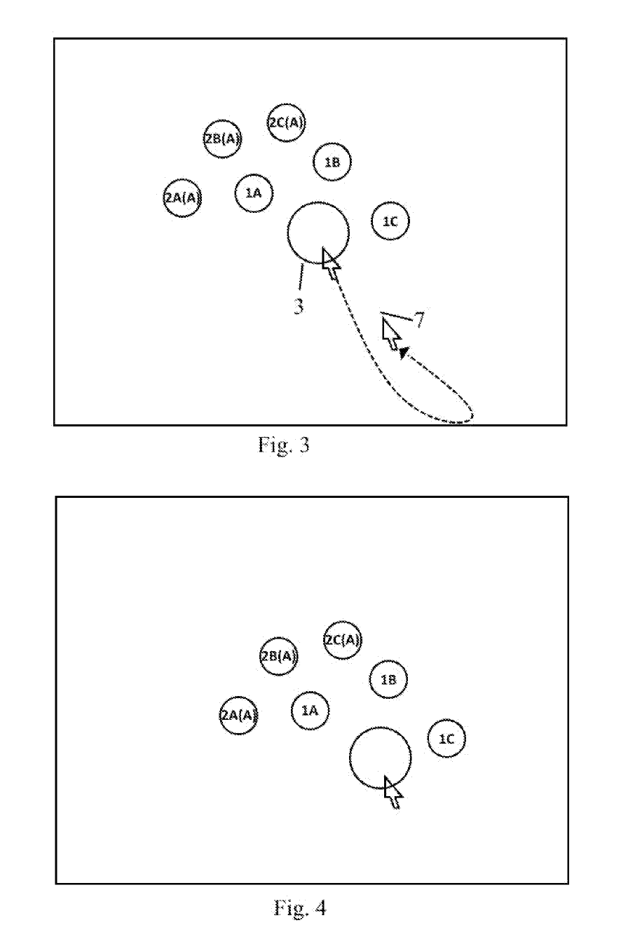

In the embodiment shown in FIG. 2, two sets of secondary graphical objects are displayed. It is best understood if they are each described as occupying separate positions, and that the primary graphical object is occupying a third. The first set of secondary graphical objects 2, which in this figure are identified as 1A, 1B, and 1C, can be said to occupy position P, while the second set of secondary graphical objects 5, identified as 2A(A), 2B(A), and 2C(A), can be said to occupy position P+1. The primary graphical object may be said to occupy a position P=0.

The secondary graphical objects in a higher position depend on a secondary graphical object in a lower position. This means that different secondary graphical objects are available to be displayed in the higher position depending on which secondary graphical object in the lower position is selected by the user 6. Here, when the user selects 1A, secondary graphical objects 2A(A), 2B(A) and 2C(A) are displayed.

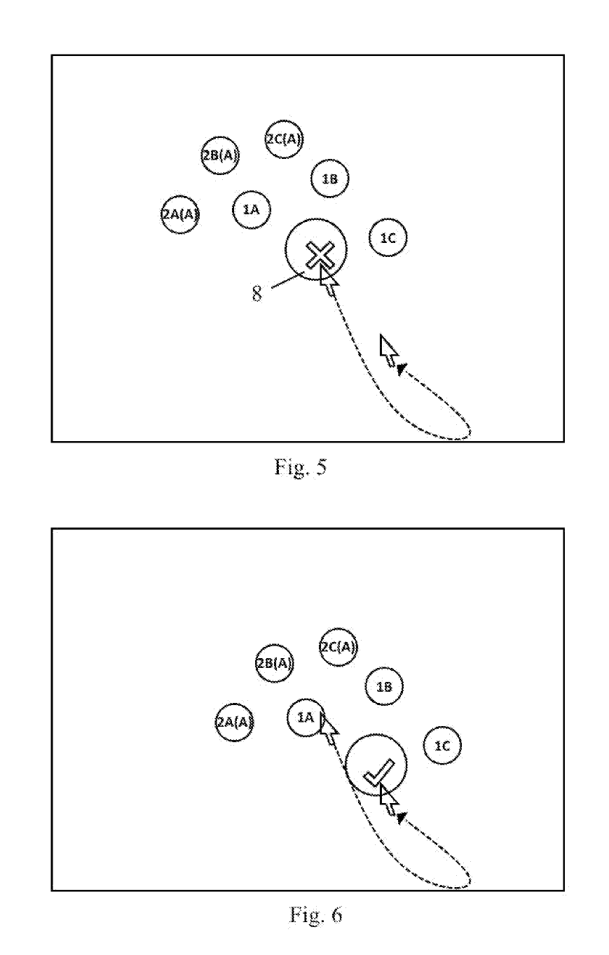

In the embodiment shown in FIG. 3-4, the primary graphical object is displayed in a first region 3 of the display device. When the user selects the primary graphical object and then selects a second region 7 of the display device, the primary graphical object is then moved to the second region.

In the embodiment shown in FIG. 5-6, a status symbol or toggle button 8 is featured on the primary graphical object. If the toggle button is selected an odd number of times, then the primary graphical object will not graphically move, even if the user selects a second region of the display device. But if the toggle button is selected an even number of times (which includes zero, i.e., not being selected at all), and the user then selects a second region, the primary graphical object will move. These two statuses, stationary and movable, are based on the toggle button. The odd/even assignment is not inevitable, and the reverse even/odd assignment is also feasible.

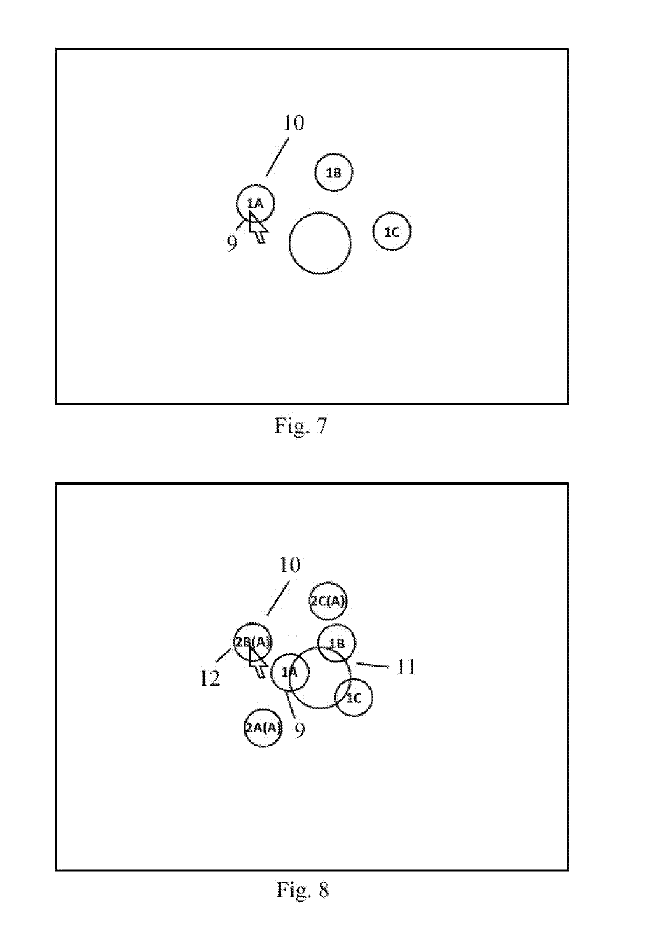

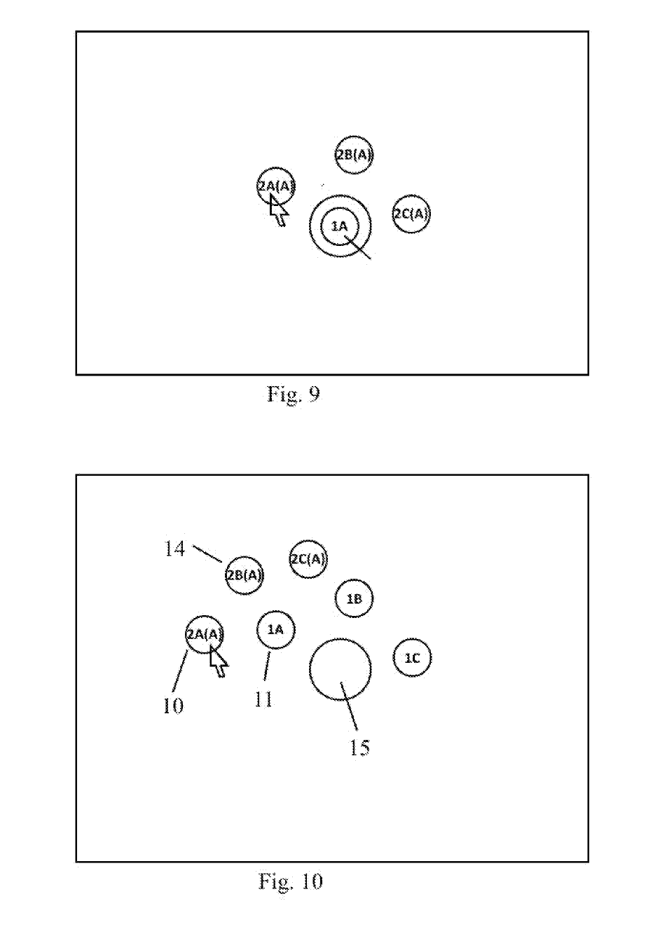

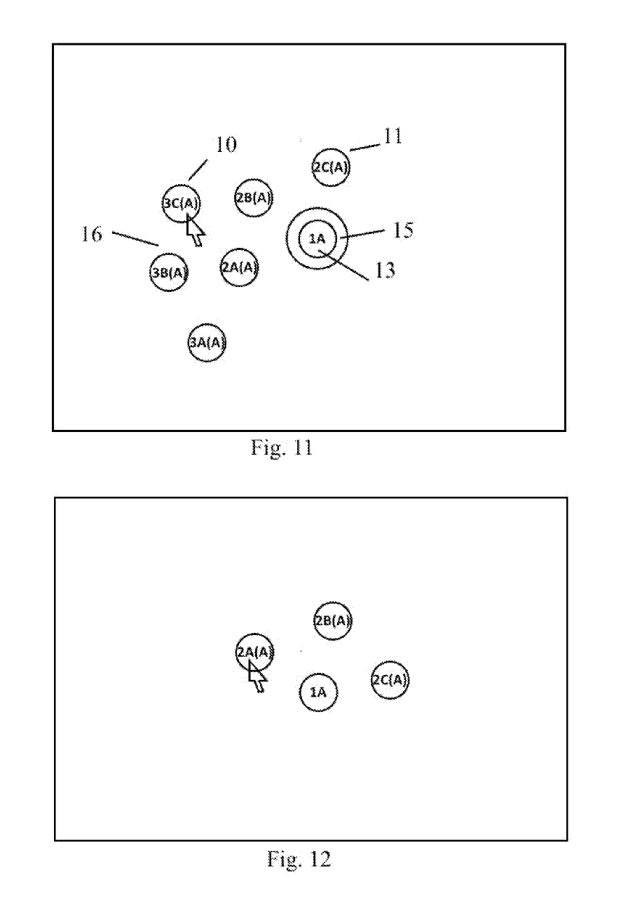

In the embodiment shown in FIG. 7, the selection of a secondary graphical object 9 in position P 10 is shown. In the embodiments shown in FIG. 8, the secondary graphical objects that were previously in position P are moved to position P−1 11, and the set of secondary graphical objects 12 that depend on the secondary graphical object selected 9 now are displayed in position P 10. In the embodiment shown in FIG. 10-11 is an alternative demonstration of this movement, which demonstrates the same steps involving an additional tier 14 of secondary graphical objects. Here, the set of 2A(A), 2B(A), and 2C(A), all of which are in position P, 10 depend on 1A, which is in position P−1 11. When 2A(A) is selected, 1A moves to position P−2 15, and 2A(A), 2B(A), and 2C(A) move into position P−1. The set of secondary graphical objects 16 that depend on 2A(A)-3A(A), 3B(A), and 3C(A)—are displayed in position P 10. In this example, P−2 may be said to correspond to P=0, and so 1A is moved so that it overlaps the primary graphical object, and 1B and 1C are no longer displayed, since the secondary graphical objects in position P−1 11 do not depend on them. FIGS. 7 and 9 also demonstrates the display of a secondary graphical object occupying position P=0 13 with the other secondary graphical objects in its set no longer being displayed.

In another version, however, 1B and 1C do not disappear, but simply fall in with 1A in position P−1, which may or may not overlap the primary graphical object, but are nonetheless deposed from their preceding position with respect to the primary graphical object.

In the embodiment shown in FIG. 12, the primary graphical object is no longer displayed when a secondary graphical object moves into position P=0 13.

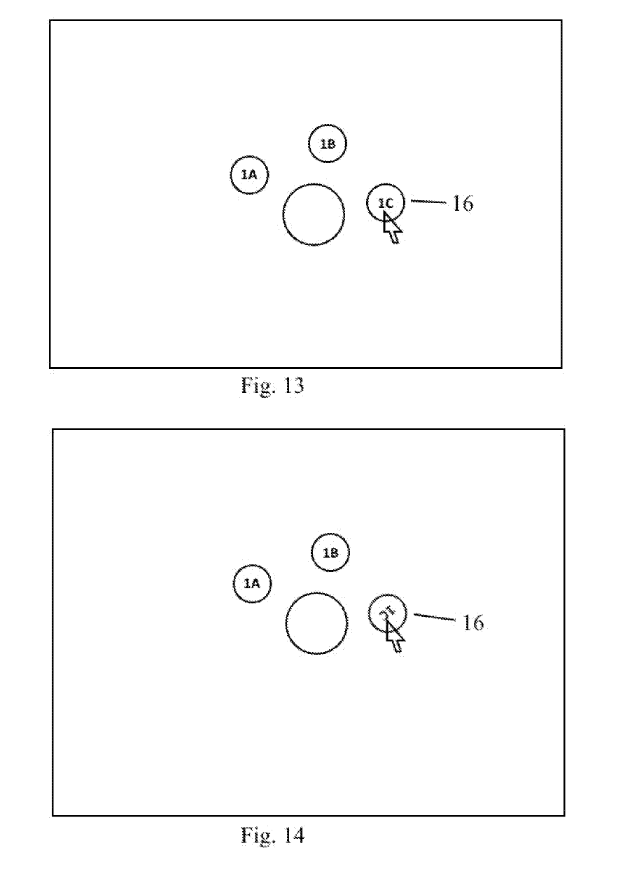

In the embodiment shown in FIG. 13-14, a secondary graphical object 16 is displayed to rotate around its own center after being selected.

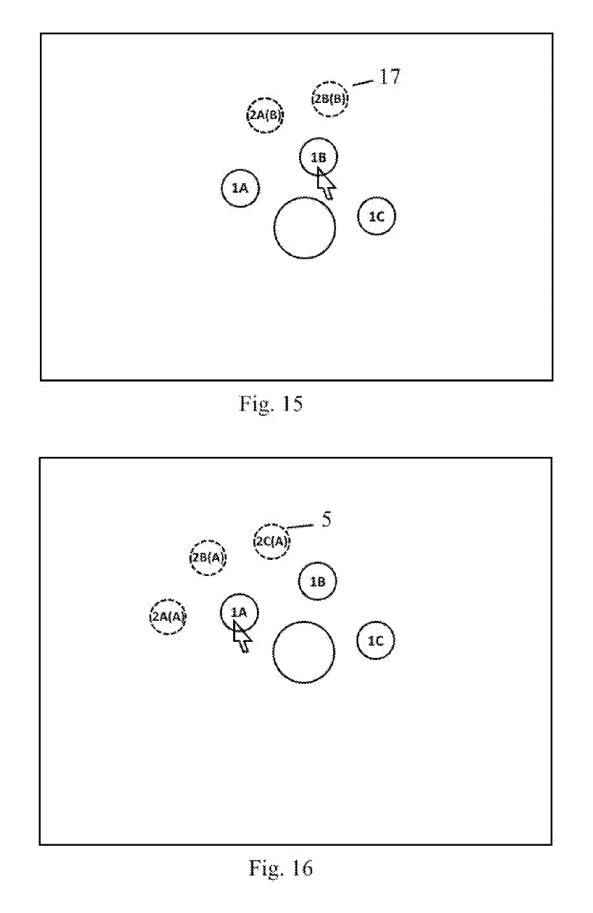

In the embodiment shown in FIG. 15-16, a display of the secondary graphical objects 5 that depend on a secondary graphical object are displayed partially transparently. This transparent display is the result of a tentative user selection, which may be enacted by the user hovering the mouse or selection device over the depended secondary graphical object rather than finalizing the selection. This finalizing may occur by a click or other means. If a finalized selection is made in the system as shown in FIG. 16, then the system will display the depending secondary graphical objects 5 opaquely, as in FIG. 2.

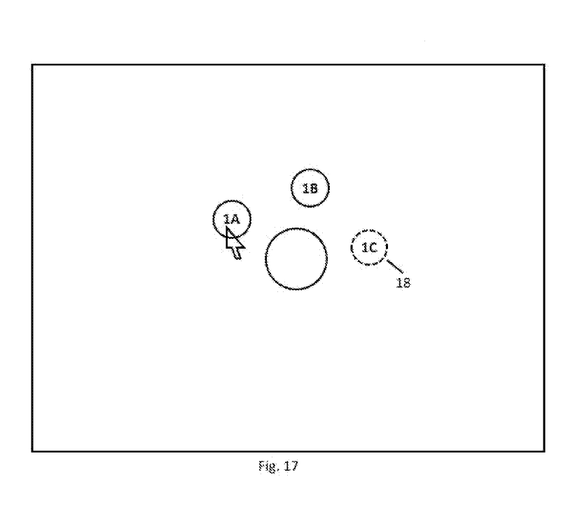

In the embodiment shown in FIG. 17, a secondary graphical object is displayed partially transparently 18, if it is not selectable or executable by the user.

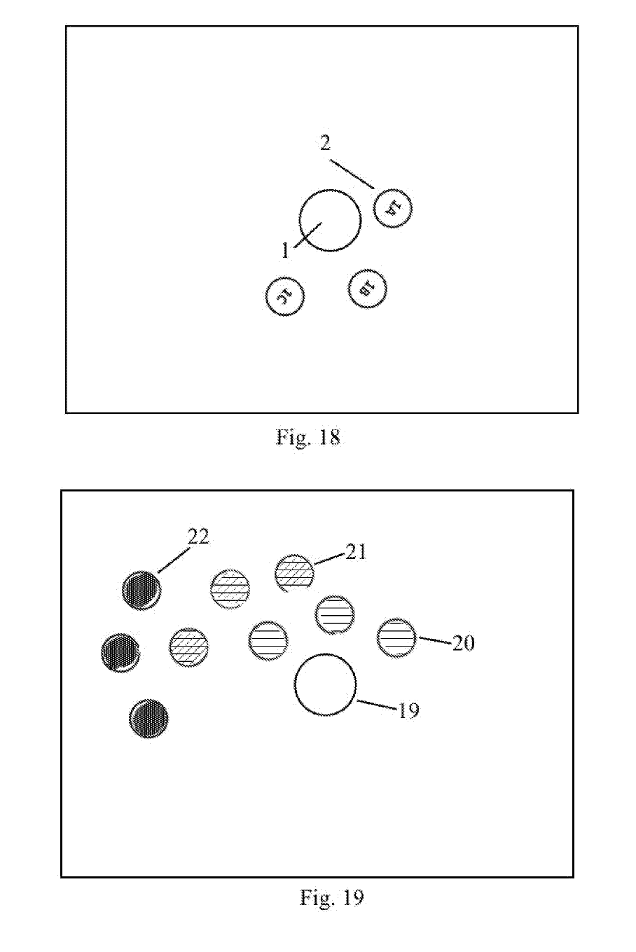

In the embodiment shown in FIGS. 2 and 18, the secondary graphical objects 2 rotate around their collective center—that is, the primary graphical object 1 that they surround.

In the embodiment shown in FIG. 19, the graphical display of the secondary graphical objects are distinguished based on their position. Here, there are four positions, 19, 20, 21, and 22, and they are graphically distinguished using shading. There may be other ways to graphically distinguish as well. The shades here also serve as an analog for sound, in that pitch may vary from low to high, based on the position of each secondary graphical object. It is conceivable that multiple processors may be employed in executing instructions derived from remotely located memory sources.

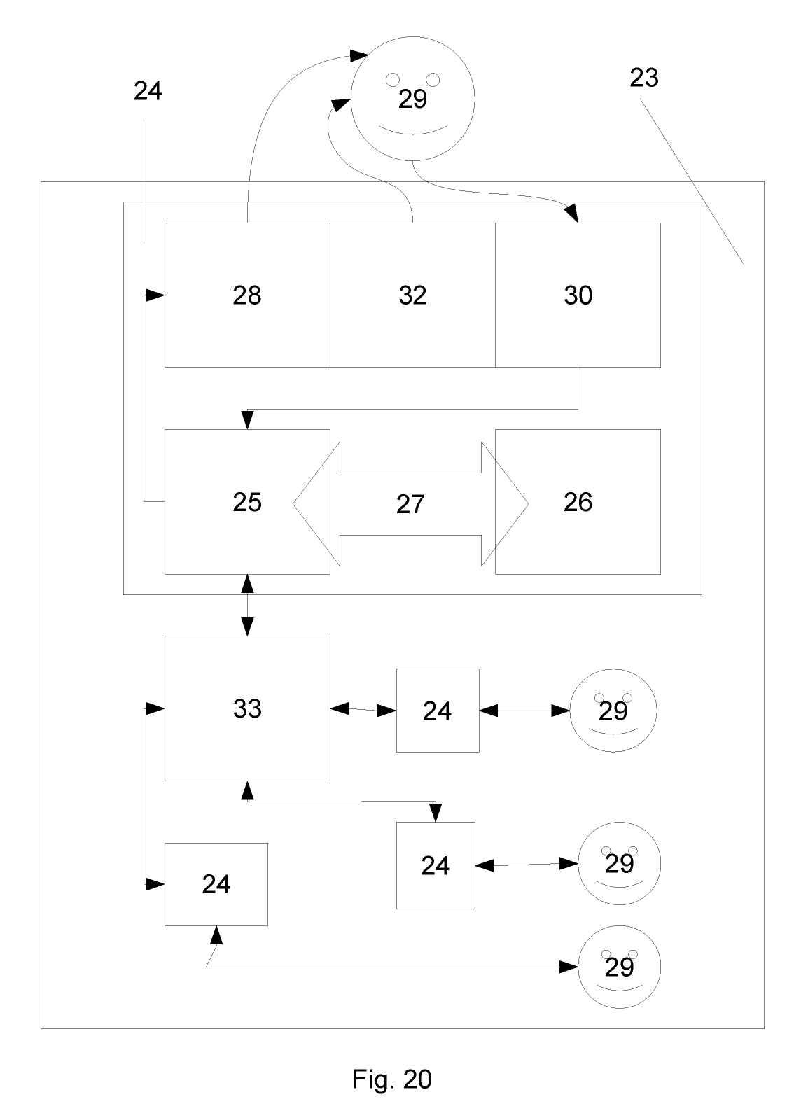

As shown in FIG. 20, a computer system 23 for performing the embodiments described herein may comprise one or more programmed computers 24. Each programmed computer may comprise a processor 25 engaged with a computer memory 26 to execute instructions 27 loadable onto and then provided by the computer memory. The computer system may also comprise one or more display devices 28 to graphically display to a user 29 the embodiments described herein, and one or more input devices 30 to receive selection, indication, and movement instructions from the user. The computer system may be embodied by a traditional desktop computer, a laptop, or mobile device.

Another embodiment of the computer system comprises a sound emitting device 32. In yet another embodiment, the computer system accesses a network 33, which may connect it to one or more other programmed computers and users.

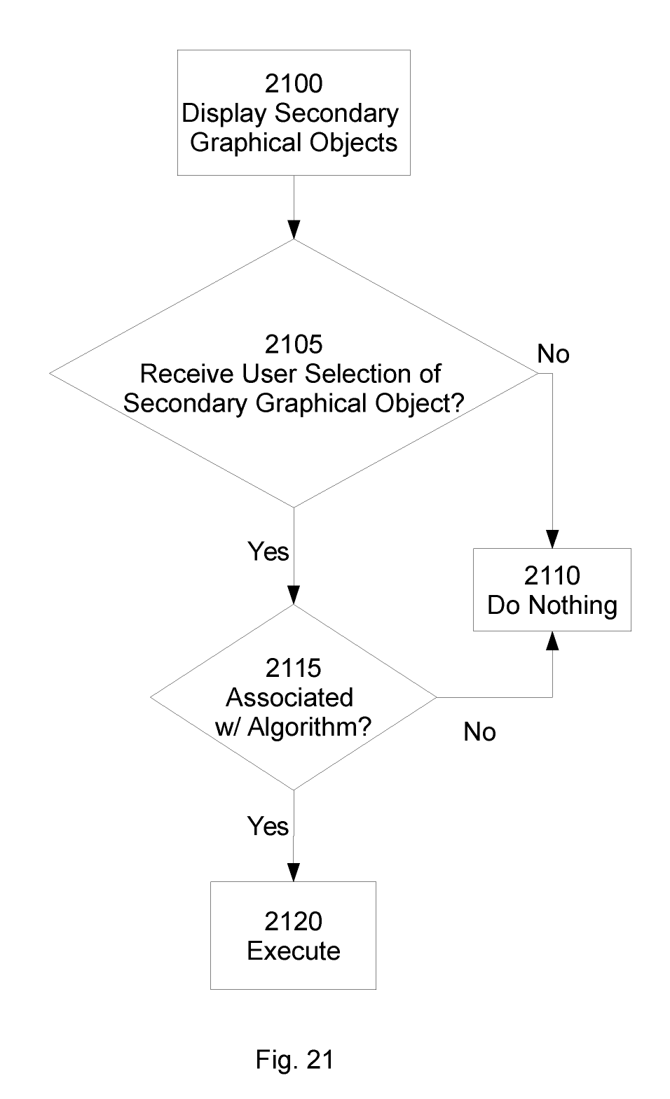

In the embodiment shown in FIG. 21, the process 2100 graphically represents at least three secondary graphical objects, each secondary graphical object distinguishable from each of the others by its graphical location in respect to the primary graphical object and its appearance, as displayed on the display device. Generally, the appearance of each object serves to inform the user what can be expected from selecting it.

The process 2105 determines whether a user selection of one of the secondary graphical objects from 2100 are received. If a selection is not received, then the process 2110 may do nothing. Here, as elsewhere, the step of “doing nothing” need not exclude other steps that may be described elsewhere in the application, but merely as a negation of some other step—and this is not absolutely true, for that other step may still occur if other requirements as disclosed elsewhere in this application are met.

In this embodiment, if a user selection is received, then the process 2115 determines whether the selected secondary graphical object is executably associated with a set of algorithm. If so, then the process 2120 executes those algorithms. Otherwise, the process 2110 does nothing.

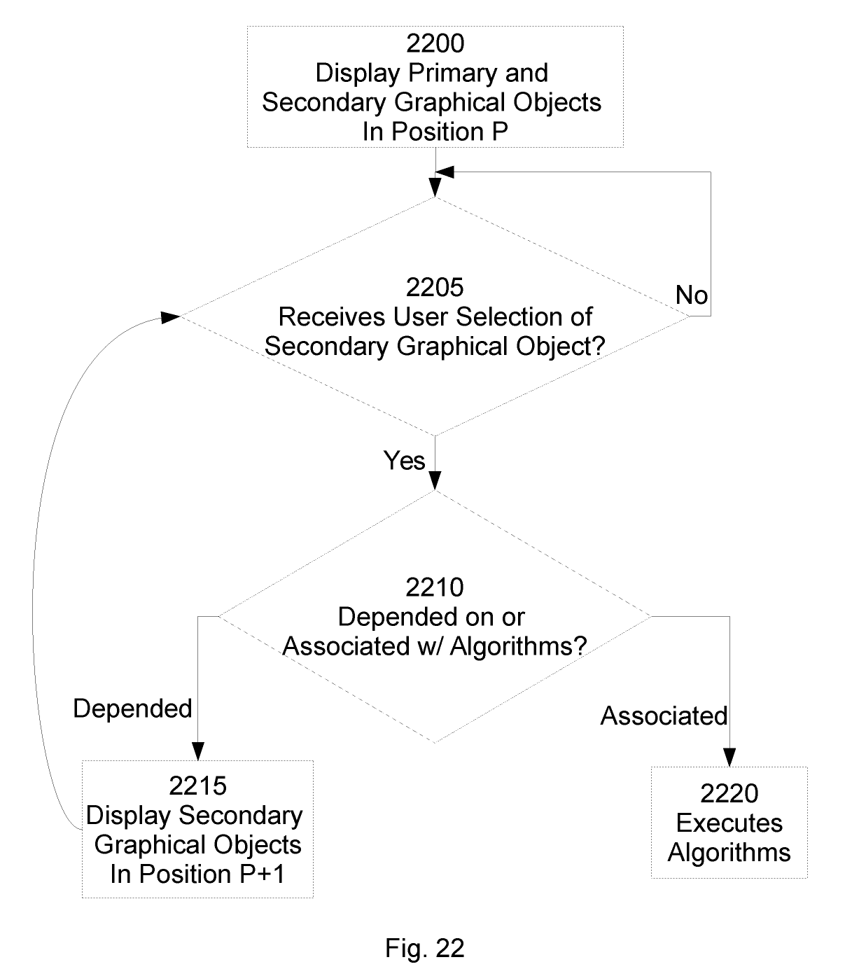

In the embodiment shown in FIG. 22, the process 2200 graphically represents on the display device a primary graphical object and an arrangement of secondary graphical objects in position P on a display device. The arrangement of secondary graphical objects may substantially surround the primary graphical object in a circular or semi-circular shape. The process then 2205 determines whether a user selection of a secondary graphical object in the arrangement of secondary graphical objects is received. If the process does determine such a selection, then it 2210 determines whether the selected secondary graphical object is depended upon by a set of secondary graphical objects or executably associated with a set of algorithms.

If the process determines that the selected secondary graphical object is depended upon, then the process 2215 displays that set of secondary graphical objects in position P+1. If the process determines that the selected secondary graphical object is executably associated with a set of algorithms, then the process 2220 executes that set of algorithms.

The step in 2215 may recursively lead back to step 2205, in that a second secondary graphical object may be selected from either the set of secondary graphical objects in 2215 or among the arrangement in 2200.

While graphical objects can be described as being graphically displayed in positions and/or regions of the display device, it should be understood that position is relational to other graphical objects, principally the primary graphical object, while region refers to particular coordinates on the display device. Further, position is generally arcuatous in shape, and more than one secondary graphical object can be disposed in any given position. Therefore, the process can display the same secondary graphical objects in the same position but in a different region of the display device, or substantially different secondary graphical objects in different positions but in the same region.

There are two general schemes for position described in this application. In the first scheme, all positions are more or less cocentrically disposed surrounding the position P=0, which is generally occupied by the primary graphical object, unless the primary graphical object is replaced by a secondary graphical object upon which all other simultaneously displayed secondary graphical objects depend. In the second scheme, each position is more or less disposed surrounding a secondary graphical object upon which all of the secondary graphical objects occupying that position depend.

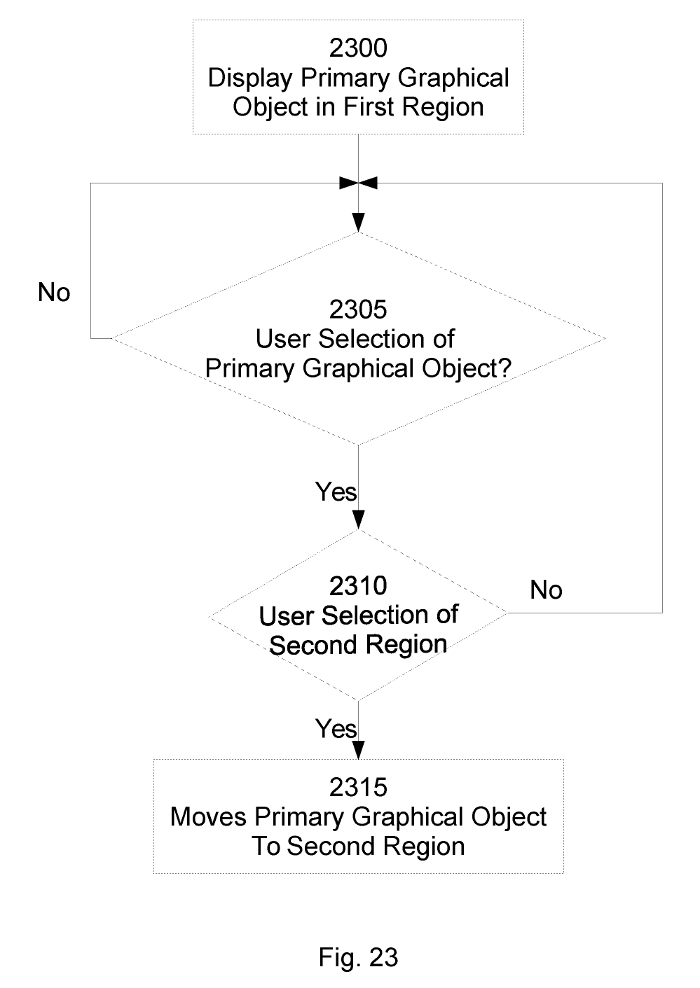

In the embodiment shown in FIG. 23, the process 2300 graphically represents a primary graphical object in a first region of the display device. The process 2305 determines whether a user selection of the primary graphical object is received. The precise selected area may not be significant so long as there is some area on or adjacent to the primary graphical object that can be selected in this manner for the purposes of moving the primary graphical object.

If the process determines that the user selection is received, then it 2310 determines whether a user selection of a second region of the display device is received. If yes, then it 2315 graphically moves the primary graphical object from the first region to the second region of the display device.

The second region should be understood to constitute a region that can actually be occupied by the primary graphical object—that is, one that is not obstructed or occupied by another component of the user interface that would not move along with the primary graphical object, or by an aspect of the user interface external to the selectable area of the application, as it is displayed on the display device. It is conceivable that the user has selected some other functional or neutral component of the user interface, or perhaps even a separate application or component thereof. In one embodiment, if a user selection of a second region of the display device is not received, then the initial receiving of the primary graphical object may be ignored or negated.

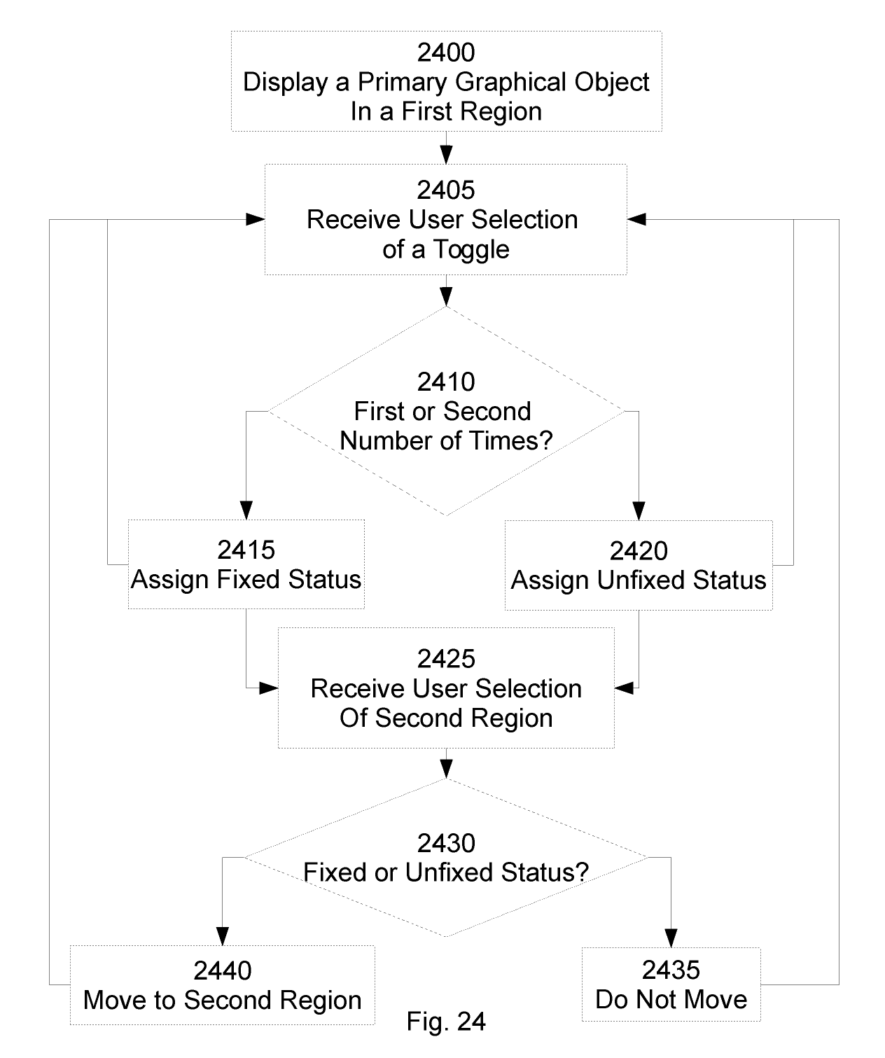

In the embodiment shown in FIG. 24, the processes 2400 graphically represents a graphical object in a first region of the display device. The process 2405 receives a user selection of a toggle button, switch or status symbol, which may occupy a sub-area of the primary graphical object, its entirety, or an area adjacent to it. If 2410 the user selection of the toggle occurs some number of times, such as even times, then 2415 the primary graphical object is assigned a fixed status. If it is received some other number of times, such as odd times, then 2420 the primary graphical object is assigned an unfixed status.

Thereafter, the process may 2425 receive a user selection of a second region of the display device. The process 2430 then determines whether a fixed or unfixed status is assigned. Either a fixed or unfixed status may be automatically assigned as a default status. If a fixed status, then the process 2435 does not move the primary graphical object. If an unfixed status is assigned, then the process 2440 moves the primary graphical object to the second region.

A move may constitute a substantially sudden disappearance in the first region followed by a substantially sudden appearance in the second region, or a transitional movement from the first region to the second region.

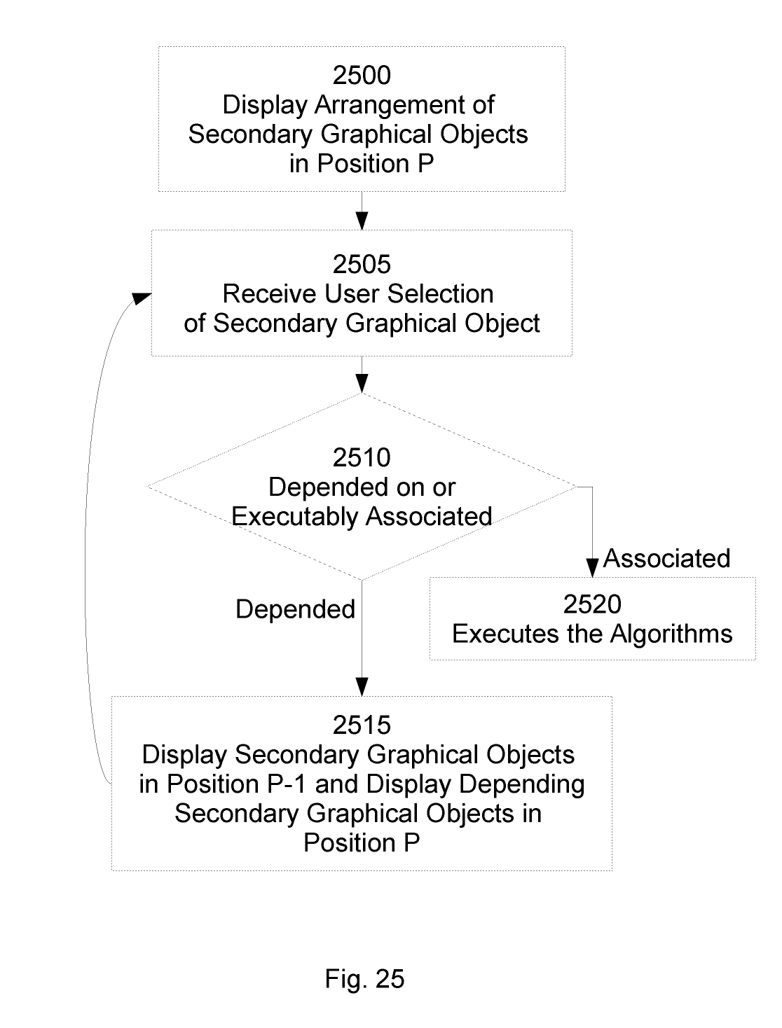

In the embodiment shown in FIG. 25, the process 250 graphically represents an arrangement of secondary graphical objects in position P. The process receives a user selection of a secondary graphical object and 2510 determines whether the selected secondary graphical object is depended upon by a set of secondary graphical objects or executably associated with a set of algorithms. If the process determines that the selected secondary graphical object is depended upon, then it 2515 displays the secondary graphical objects in which the selected graphical object resides in position P−1 and the secondary graphical objects depending on the selected secondary graphical object in position P. The process is then recursively linked to step 2505. If the process determines that the selected secondary graphical object is executably associated with a set of algorithms, then it 2520 executes that set of algorithms.

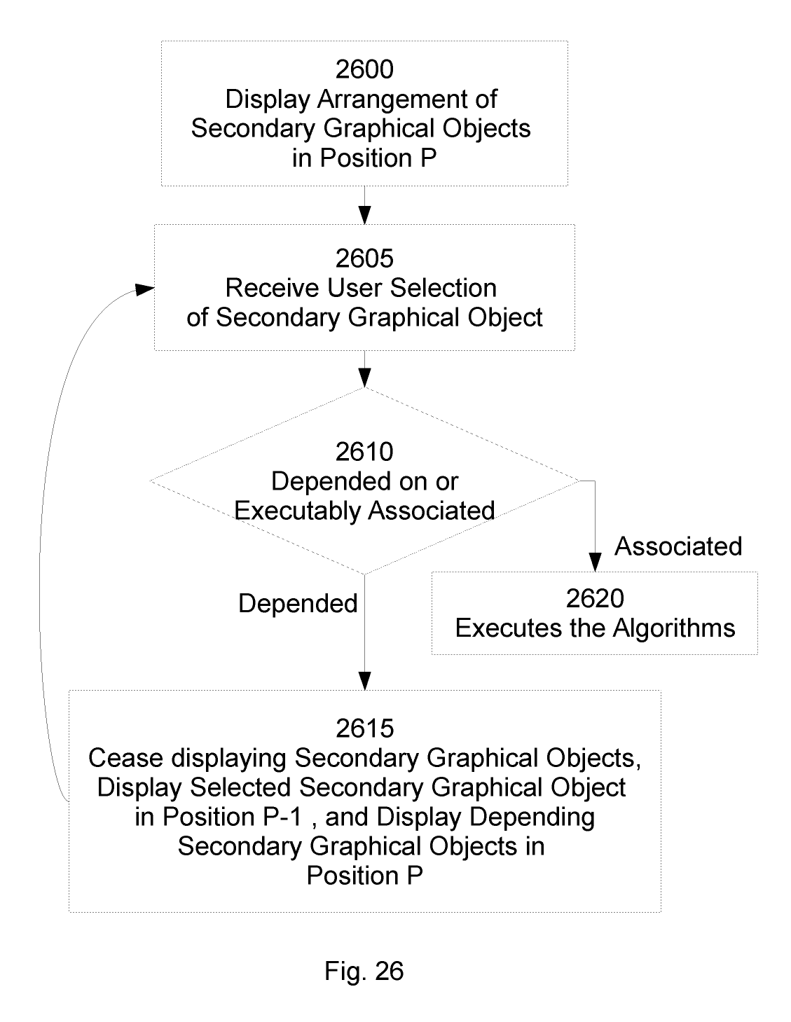

In the embodiment shown in FIG. 26, the process graphically 2600 represents an arrangement of secondary graphical objects in position P and the 2605 receives a user selection of a secondary graphical object. The process 2610 determines whether the secondary graphical object is depended upon by a set of secondary graphical objects or executably associated with a set of algorithms. If the process determines that the selected secondary graphical object is depended upon, then it 2615 ceases displaying the secondary graphical objects in which the selected secondary graphical object resides, displays the selected secondary graphical object in position P−1, and displays the depending set of secondary graphical objects in position P.

If the process determines that the selected secondary graphical object is executably associated with a set of algorithms, then it 2620 executes that set of algorithms. Step 2615 is recursively linked to step 2605.

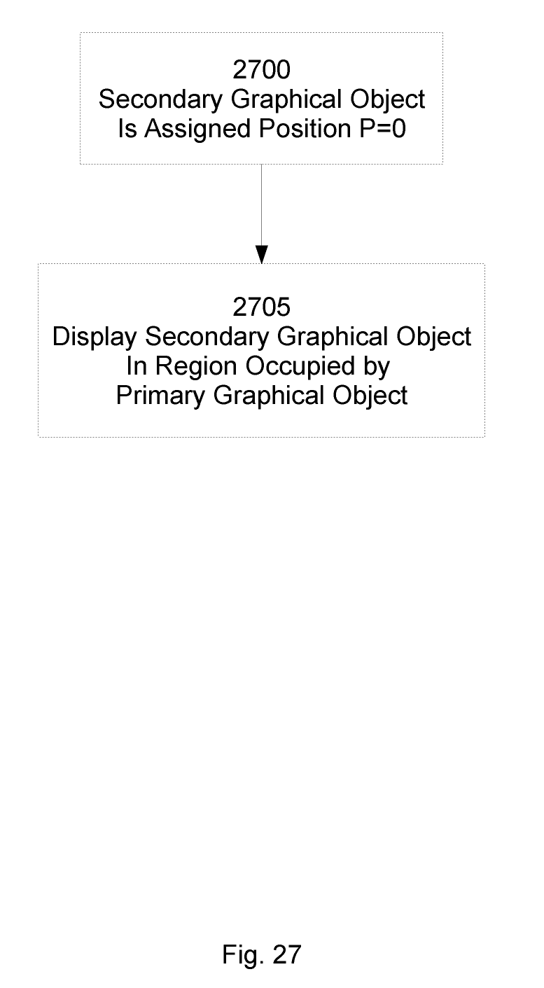

In the embodiment shown in FIG. 27, a secondary graphical object is assigned 2700 position Position P=0. The process 2705 displays the secondary graphical object in the region of the display device occupied by the primary graphical object.

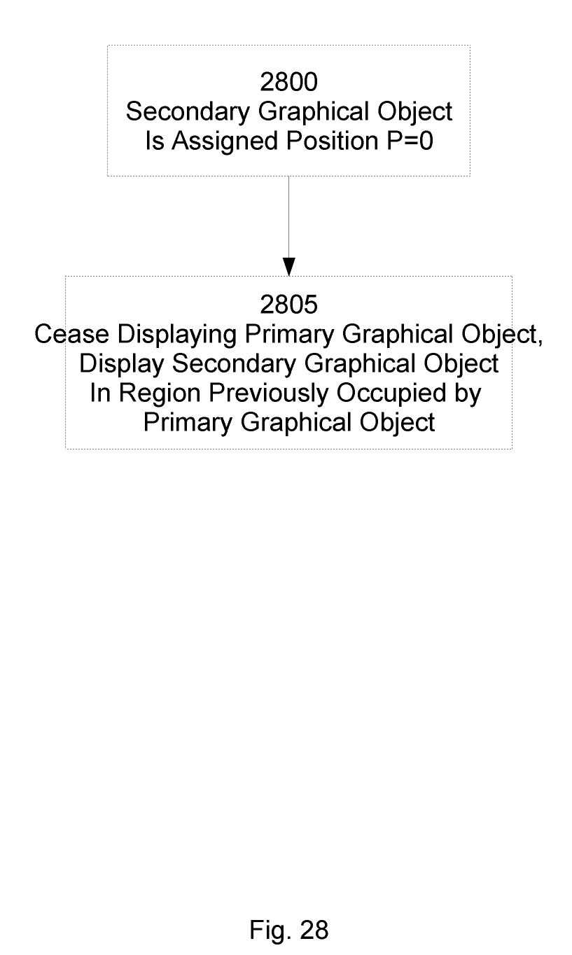

In the embodiment shown in FIG. 28, a secondary graphical object is assigned 2800 position Position P=0. The process 2805 ceases displaying the primary graphical object and displays the secondary graphical object in the region of the display device occupied by the primary graphical object.

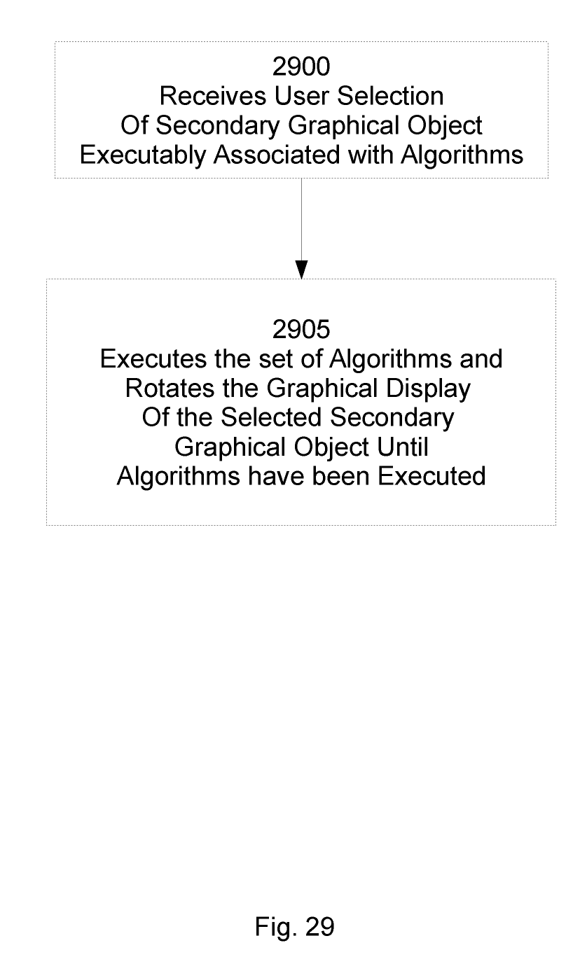

In the embodiment shown in FIG. 29, the process 2900 receives a user selection of a graphical object executably associated with a set of algorithms, then it 2905 executes the set of algorithms and 2910 rotates the graphical display of the selected secondary graphical object until the set of algorithms have completed execution.

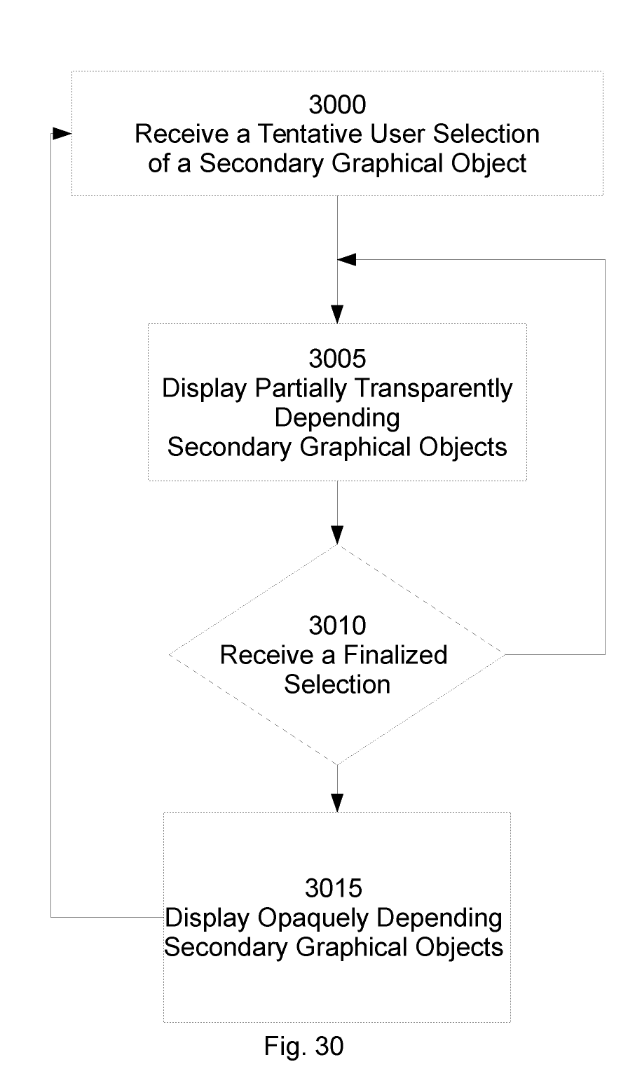

In the embodiment shown in FIG. 30, the process 3000 receives a tentative user selection of a secondary graphical object, then 3005 graphically displays partially transparently a set of secondary graphical objects dependent on the selected secondary graphical object. If 3010 a finalized selection of a secondary graphical object is received, then the process 3015 graphically displays opaquely the depending secondary graphical objects.

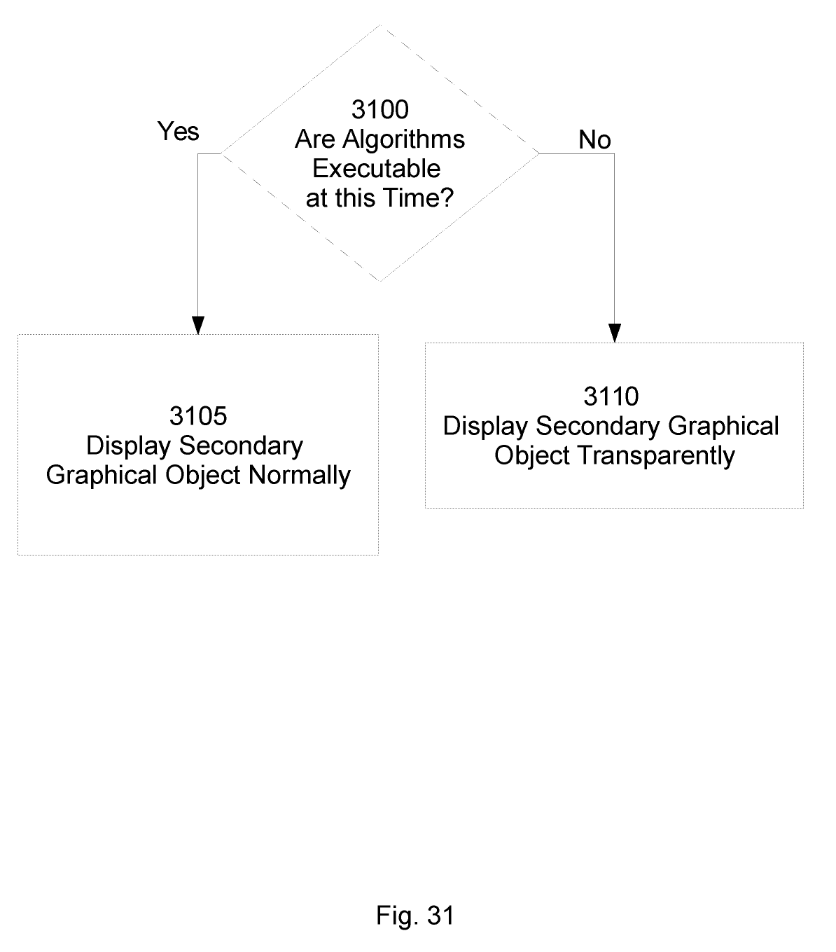

In the embodiment shown in FIG. 31, the process 3100 determines whether a set of algorithms executably associated with a secondary graphical object are executable at the time. If they are, then the process 3105 graphically displays the secondary graphical object normally. Otherwise, the process 3110 displays the secondary graphical object at least partially transparently. In another embodiment, the secondary graphical object is not displayed at all.

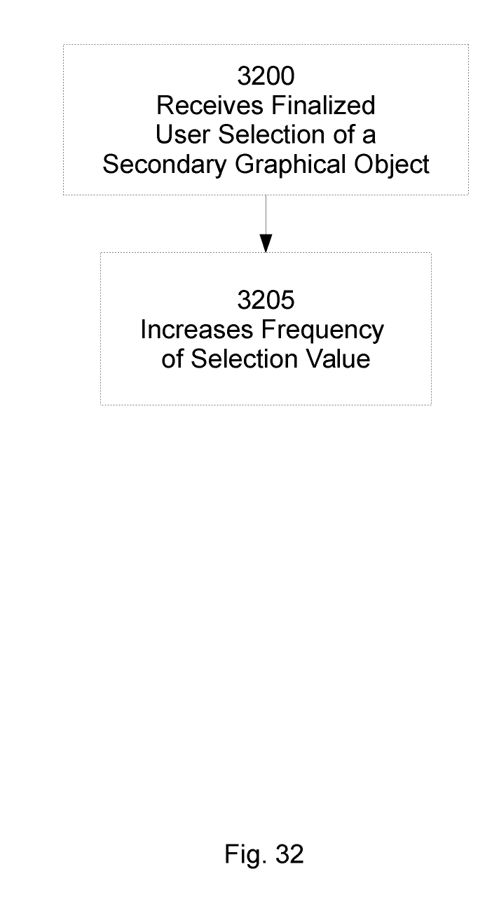

In the embodiment shown in FIG. 32, the process 3200 receives a finalized user selection of a secondary graphical object, then 3205 adds to the frequency of selection value associated with the selected secondary graphical object.

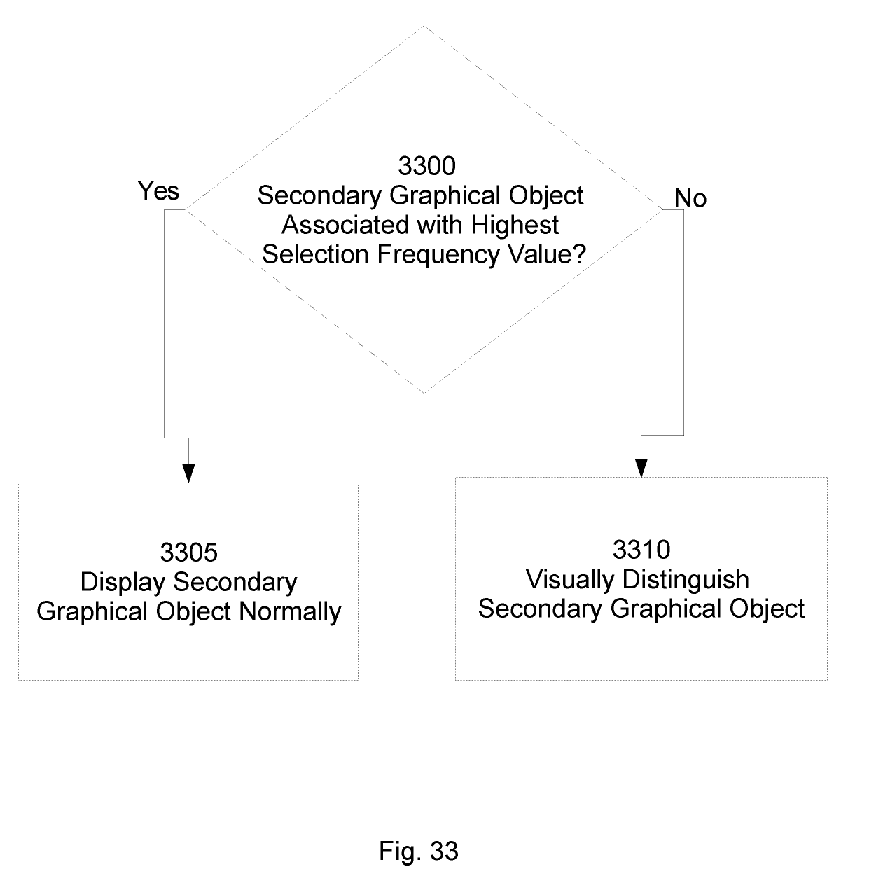

In the embodiment shown in FIG. 33, the process 3300 determines whether a secondary graphical object in a set is associated with a frequency of selection value higher than the others. If it does not, the process 3305 graphically displays the secondary graphical object normally. Otherwise, the process 3310 visually distinguishes the graphical display of the secondary graphical object from the others.

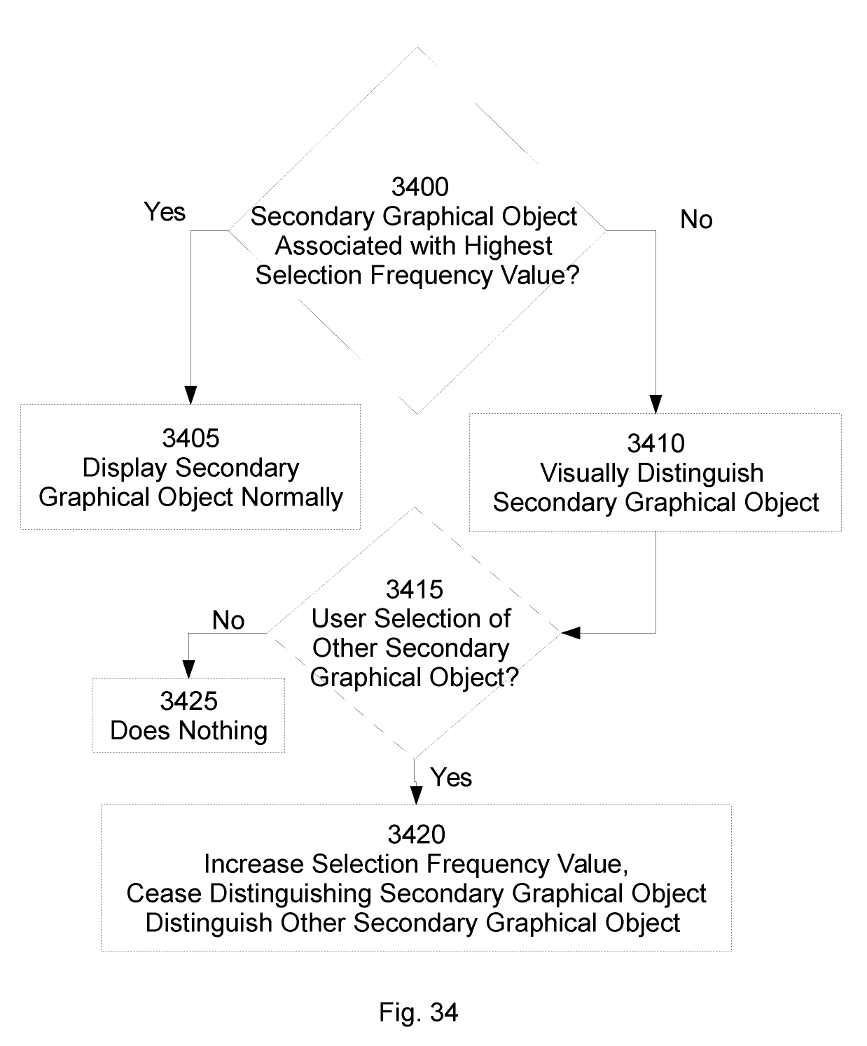

In the embodiment shown in FIG. 34, the process 3400 determines whether a secondary graphical object in a set is associated with a frequency of selection value higher than the others in the set. If it does not, the process 3405 graphically displays the secondary graphical object normally. Otherwise, the process 3410 visually distinguishes the graphical display of the secondary graphical object from the others. Then the process 3415 determines whether a user selection of some other secondary graphical object in the same set is received. If so, then the process 3420 increases the selection frequency value, ceases visually distinguishing the graphical display of the secondary graphical object associated with the highest selection frequency value, and visually distinguishes the secondary graphical object selected in 3415. Otherwise, the process 3425 does nothing.

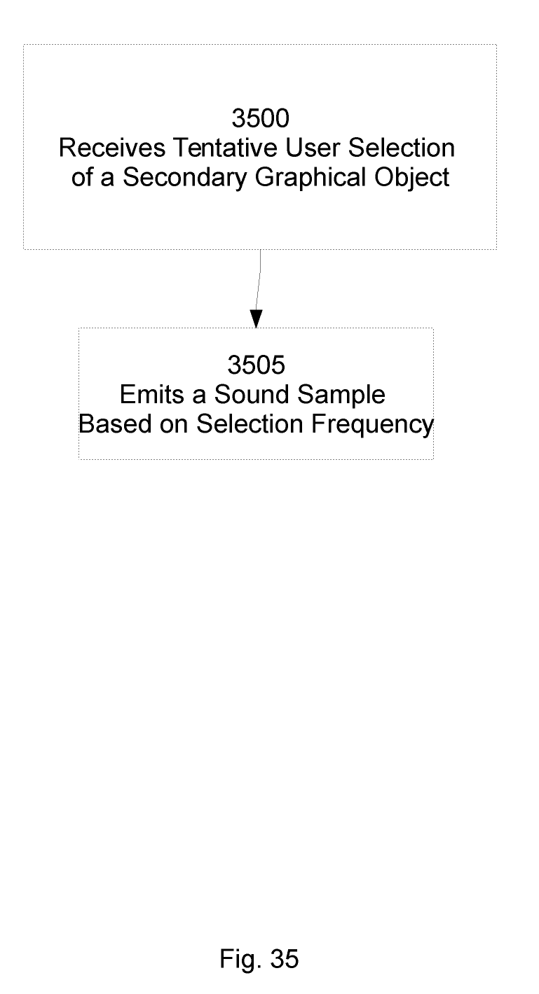

In the embodiment shown in FIG. 35, the process 3500 receives a tentative user selection of a secondary graphical object and then 3505 emits a sound sample based on the selection frequency of the tentatively selected secondary graphical object.

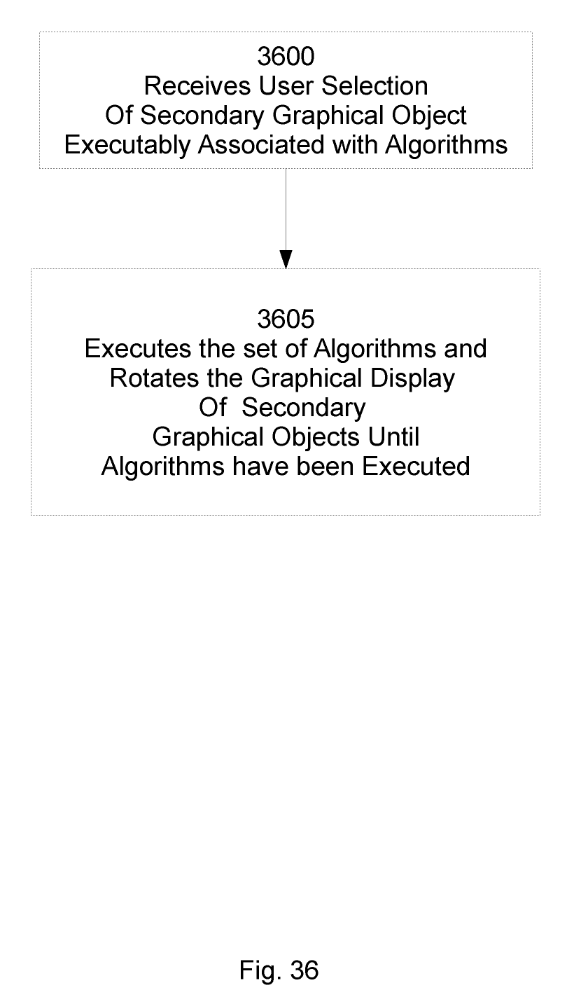

In the embodiment shown in FIG. 36, the process 3600 receives a user selection of a graphical object executably associated with a set of algorithms, then it 3605 executes the set of algorithms and rotates the graphical display of secondary graphical objects until the set of algorithms have completed execution.

1. An apparatus comprising:
a computer having a computer-readable storage memory, a display device, and an input device, the computer programmed to:
graphically represent a primary graphical object in a first region of the display device;
graphically represent secondary graphical objects approximately surrounding the primary graphical object, where the secondary graphical objects are individually distinguishable by their graphical locations and appearances on the display device; and
upon receiving a user selection of a secondary graphical object executably associated with a set of algorithms, execute the set of algorithms.

2. An apparatus comprising:
a computer having a computer-readable storage memory, a display device, and an input device, the computer programmed to:
graphically display a primary graphical object in a first region of the display device;
graphically display in a position P an arrangement of secondary graphical objects, where position expresses graphical distance from the primary graphical object;
upon receiving a user selection of a secondary graphical object in position P depended upon by a dependent set of secondary graphical objects, graphically display in a position P+1 the dependent set of secondary graphical objects; and
upon receiving a user selection of a secondary graphical object executably associated with a set of algorithms, execute the set of algorithms.

3. The apparatus in claim 2, additionally programmed to:
upon receiving a user selection of the primary graphical object and a user indication of a second region of the display device, graphically move the primary graphical object from the first region to the second region.

4. The apparatus in claim 3, additionally programmed to:
upon receiving a user selection of a toggle, alternatively assign a fixed status or an unfixed status to the primary graphical object depending on the number of user selections of the toggle;
and when the fixed status is assigned, not permit the graphical moving of the primary graphical object from the first region to the second region.

5. The apparatus in claim 2, additionally programmed to:
upon receiving the user selection of the secondary graphical object in position P depended upon by the dependent set of secondary graphical objects, graphically display in position P−1 the arrangement of secondary graphical objects that was displayed in position P, and graphically display in position P the dependent set.

6. The apparatus in claim 2, additionally programmed to:
upon receiving the user selection of the secondary graphical object in position P depended upon by the dependent set of secondary graphical objects, cease graphically displaying the arrangement of secondary graphical objects that was displayed in position P, graphically display the selected secondary graphical object in position P−1, and graphically display in position P the dependent set.

7. The apparatus in claim 6, additionally programmed to:
if the selected secondary graphical object is to be displayed in position P−1, and P−1=0, display the selected secondary graphical object in the region of the display device occupied by the primary graphical object.

8. The apparatus in claim 7, additionally programmed to:
cease graphically displaying the primary graphical object.

9. The apparatus in claim 2, additionally programmed to:
after receiving the user selection of the secondary graphical object executably associated with the set of algorithms, execute the set of algorithms and rotate the graphical display of the selected graphical object until the set of algorithms have completed execution.

10. The apparatus in claim 2, additionally programmed to:
after receiving the user selection of the secondary graphical object executably associated with the set of algorithms, execute the set of algorithms and rotate the graphical display of secondary graphical objects until the set of algorithms have been executed.

11. The apparatus in claim 2, additionally programmed to:
graphically display at least partially transparently secondary graphical objects depending on a tentatively selected secondary graphical object; and
graphically display opaquely secondary graphical objects depending on a selected secondary graphical object if the selection is finalized.

12. The apparatus in claim 2, additionally programmed to:
graphically display at least partially transparently the secondary graphical object executably associated with the set of algorithms if an instruction has been received not to run the set of algorithms.

13. The apparatus in claim 2, additionally programmed to: record a finalized selection frequency value for each secondary graphical object and distinguish the secondary graphical objects from one another based on their finalized selection frequency values.

14. The apparatus in claim 13, where:
the distinguishing is graphical.

15. The apparatus in claim 14, additionally programmed to:
when a finalized user selection of a secondary graphical object is received, cease distinguishing secondary graphical objects in the same position as the selected secondary graphical objects, if the selected secondary graphical object is depended on by a dependent set of secondary graphical objects and graphically, distinguish the secondary graphical objects in the dependent set.

16. The apparatus in claim 13, further comprising a sound emitting device, and where: the distinguishing is sonical.

17. The apparatus in claim 2, additionally programmed to:
graphically distinguish secondary graphical objects based on their position, such that secondary graphical objects in the same position are graphically displayed more similarly than secondary graphical objects in different positions.

18. The apparatus in claim 2, further comprising a sound emitting device, and additionally programmed to:
sonically distinguish secondary graphical objects based on their position, such that when a secondary graphical object is tentatively selected, a first sound sample is emitted, and if a secondary graphical object in the same position is tentatively selected, the first sound sample is emitted by the sound emitting device, but if a secondary graphical object in a different position is tentatively selected, a second sound sample is emitted by the sound emitting device.

19. The apparatus in claim 2, where:
secondary graphical objects executably associated with algorithms are graphically distinguished from secondary graphical objects not executably associated with algorithms.

20. The apparatus in claim 2, further comprising a sound emitting device, and additionally programmed to:
receive a predetermined sequence of selections of secondary graphical objects, and when the sequence of user selections of secondary graphical objects differ from the predetermined sequence of selections of secondary graphical objects, a sound sample is emitted by the sound emitting device.

21. An apparatus comprising:
a computer having a computer-readable storage memory, a display device, and an input device, the computer programmed to:
graphically display a primary graphical object in a first region of the display device;
graphically display in a position P an arrangement of secondary graphical objects, where position expresses graphical distance from the primary graphical object;
upon receiving a tentative user selection of a secondary graphical object in position P depended upon by a dependent set of secondary graphical objects, graphically display at least partially transparently and in a position P+1 the dependent set of secondary graphical objects;
upon receiving a finalized user selection of a secondary graphical object in position P depended upon by a dependent set of secondary graphical objects, graphically display opaquely and in a position P+1 the dependent set of secondary graphical objects;
upon receiving a tentative user selection of a secondary graphical object in position P+1 depended upon by a dependent set of secondary graphical objects, graphically display at least partially transparently and in a position P+2 the dependent set of secondary graphical objects;
upon receiving a finalized user selection of a secondary graphical object in position P+1 depended upon by a dependent set of secondary graphical objects, graphically display opaquely and in a position P+2 the dependent set of secondary graphical objects; and
upon receiving a finalized user selection of a secondary graphical object executably associated with a set of algorithms, execute the set of algorithms.
